(19) United States
(12) Patent Application Publication
(10) Pub. No.: US 2021/0235725 A1
(43) Pub. Date: Aug. 5, 2021

(54) METHOD OF PRODUCING EDIBLE PET CHEW PRODUCT AND PRODUCT PRODUCED THEREBY

(71) Applicant: PARAGON PET PRODUCTS EUROPE B.V., Veendam (NL)

(72) Inventors: Geraldus Gerardus Johannes SCHENNINK, Veendam (NL); Willem Theodoor Martinus PATER, Veendam (NL); Janjaap FREIJE, Veendam (NL)

(21) Appl. No.: 17/255,943

(22) PCT Filed: Jun. 26, 2019
(86) PCT No.: PCT/NL2019/050391

§ 371 Date: Dec. 23, 2020

(30) Foreign Application Priority Data
Jun. 26, 2018 (EP) 18179964.4

(51) Int. Cl. A23K 40/20; A01K 15/02; A23K 20/163; A23K 20/20; A23K 40/30; A23K 50/42

(52) U.S. Cl. CPC A23K 40/20; A01K 15/026; A23K 20/163; A61D 5/00; A23K 40/30; A23K 50/42; A23K 20/20

(57) ABSTRACT

The present invention relates to a method for producing a pet chew product by a single injection molding cycle, comprising the steps of providing a thermoplastic starch mixture; converting said mixture into a thermoplastic starch-based melt; injecting the resulting thermoplastic melt comprising said optional blowing agent in a mould cavity while partially opening the mould during melt injection; allowing the thermoplastic melt in contact with the mould cavity wall to at least partially cool and set thereby forming the outer skin of a first density or hardness; partially opening the mould during melt cooling to allow gas expansion in the non-cooled core of the injected thermoplastic melt and formation of a foamed core of a second density or hardness; allowing the melt to cool and set, and ejecting the pet chew product from the mould cavity.

### FIELD OF THE INVENTION

The invention is in the field of starch-based pet chew compositions that are effective for removing plaque from the teeth of an animal. The invention relates to a process for producing a pet's chew having the said functionality and to a pet's chew obtainable by said process.

### BACKGROUND OF THE INVENTION

Dental health problems are very common in domesticated pets. The primary source of these problems is dental plaque. This invisible film of bacteria, proteins and polysaccharides attaches to the tooth surface. Bacteria in plaque may cause caries and irritated gums (gingivitis), and tartar, the mineralized plaque that is virtually impossible to remove, is a suitable matrix for more bacterial growth and more plaque. If left untreated, plaque and tartar may cause pets to suffer from malodor, periodontal disease, gingival pockets and even bone loss.

In order to prevent dental and periodontal disease in small animals such as dogs, a wide variety of products for chewing or gnawing has been developed that are aimed to address this problem. The friction between the tooth surface and the chew product during the chewing of the pet is hereby used to reduce plaque and tartar buildup.

Since pet chew products are preferably edible (dogs swallow much of what they gnaw), as well as cheap, it is very convenient to produce moulded products by a method known as extrusion moulding, wherein a thermoplastic dough is extruded through a die system and cut into pieces of predetermined length. The shape of the die, and length of the piece, determine the shape of the final product.

To provide the mechanical cleansing function, the thermoplastic dough composition may comprise fibers (e.g. U.S. Pat. Nos. 5,296,209 and 5,431,927) or may be provided with ribs or other protrusions on the surface (e.g. EP 1 017 288 and EP 2 712 288).

Another approach to providing dental care is by adapting the texture of the pet chew. For instance, materials of a low density (e.g. 0.5 Kg/L to 1.0 Kg/L) may be used that allow the animal teeth to penetrate more deeply into the chew, thereby providing a mechanical cleansing function. Exemplary low density pet food products due to having an open, cellular structure, can be produced by extrusion of a thermoplastic material comprising water, and moving the material from a high pressure zone to a low pressure zone, thereby allowing expansion of the material (e.g. U.S. Pat. Nos. 3,908,025 and 3,965,268). A problem of this expansion method, especially when using mixtures based on pre-gelatinized starches, is that the product has an unappealing, rough surface due to the presence of blisters. This problem may be solved by using special extrusion dies having specific grooves along their opening and preventing development of steam bubbles (US2016/143320), but this limits the possibilities in providing products of various shapes and dimensions.

Although extrusion moulding of products may be beneficial in certain aspects of pet chew production, a virtually unlimited variety of 3-dimensional shaped products can be produced by using injection moulding techniques. Injection moulding is a process whereby a thermoplastic material is fed into a heated barrel, mixed, and forced by injection into the cavity of a rigid frame called a mould, where it cools and hardens (sets) to the configuration of the cavity.

U.S. Pat. No. 7,087,260 provides an example of a method for producing an animal chew by injection moulding wherein the pet chew comprises a moulded body portion having a plurality of outwardly projecting ribs adapted to contact the animal's teeth when chewed.

A general problem with products produced by high pressure injection moulding techniques is that many of them are glassy in nature and have a tendency to shatter into sharp, hard fragments when bitten. This is dangerous to the animal. Hence, products must have a certain rigidity, but must not be too brittle. This problem can be overcome by using thermoplastic starches, which may provide for excellent mechanical properties. Yet, thermoplastic starches allow for a limited range in product textures, as this range is determined by the range wherein the starch composition is able to melt and solidify.

Starch-based products require specific production steps wherein the starch is gelatinized or destructurized. When combined with plasticizers and fibers, extrusion of the mixture results in conversion of the starch from an ordered into an unordered, amorphous structure (destructurizing), which yields a thermoplastic, processable material that can be shaped by injection moulding.

US 2003/0219516 describes pet chews based on potato starch, wherein a starch-based mixture is extruded to a thermoplastic mass which is subsequently moulded into a desired shape by injection moulding.

Injection moulding of starch-based thermoplastic masses to form pet chews is also described in US 2007/0212473 and US 2011/0076366.

The above-described pet chew products are structurally uniform, meaning that their density/texture is essentially homogeneous throughout the material, over the full dimension of the product. For instance, it is known from U.S. Pat. No. 6,180,161 that expansion of injection moulded starch-based pet chews by microwave irradiation may result swelling of the material and a reduction in the hardness of the chew, thereby producing a pet chew of lower density, but this material is, again, homogeneous in density/texture throughout the product. In all prior art methods of injection moulding pet chews with a lower hardness or lower density, the density of the final product is more or less homogeneous, i.e. it is either of a lower hardness or density, or of a higher hardness or density.

The prior art therefore teaches pet chew products having either, a more of less homogeneous texture/density distribution, or that possess a irregular surface due to uncontrolled foaming, or that are not produced via a single shot process.

It would, however, be beneficial from the perspective of the intended mechanical cleansing function, if lower hardness or density portions could be combined with higher hardness or density portions in a single product. For instance, it would be beneficial if a product could be provided which would allow an animal's teeth to penetrate deeply due to being of a low-density, while at the same time also providing friction with the surface of the teeth by virtue of having higher density portions.

It is however, very difficult to make products of different texture through the process of injection moulding which are at the same time well defined in both shape and dimensions. The reason is that the injection moulding is a complex process, wherein a melt is injected into a mould cavity under pressures well in excess of several hundreds of bars, and the process is only efficient for producing pet products when the finished product is produced in a single run (i.e. a single closing and opening cycle of the mould).

Pet chews having internal and external materials of different rigidity are for instance disclosed in U.S. Pat. No. 7,851,001. But the method to produce such chews requires two cycles, one cycle for producing a core portion having a first hardness, and another cycle for adding the material to the mould for forming the body having a second hardness, wherein the second material is melted and formed over the first material. It is clear that such a process is economically less feasible.

US2014/0113032 discloses an aerated pet chew composition comprising 15-90% protein, water and an amount of supercritical fluid that can be transformed to gas, and wherein the gas produces bubbles in the composition. The pet chew composition of US2014/0113032 comprises 15-90% of protein and represents a thermoplastic protein-based material, meaning that the products have a binding matrix essentially consisting of protein. Moreover, the teaching is aimed at the production of a mono-texture product that is a substantially homogeneous molded mass. Moreover, the process requires that the product is subjected to a de-flashing process, consisting of vibration of the product inside vibrating hoppers, vibrating tables and/or tumblers wherein the products are trimmed and excess material on the product is removed. This is due to the over-flow of the mould, as cell nucleation and expansion is achieved by manipulation of the temperature and pressure during injection moulding.

In fact, expanded low-density pet chews of the prior art, whether prepared by extrusion (e.g. US2016/143320) or injection moulding (e.g. US 2011/139087 and US2014/0113032), are based on mixtures containing high amounts of protein, such as flours, caseinate or gluten, and are therefore protein-based, meaning that the binding matrix largely or essentially consists of protein. The expansion (or foaming) behavior of thermoplastic protein-based compositions is considerably better than that of low (or zero)-protein compositions, such as starch-based compositions. Another problem of these starch-containing pet chews produced by injection moulding is that the individual products show large variation in surface texture, shape and dimension.

There is still a need for a pet chew product which is known to be acceptable to pets, which is inexpensive, which combines portions with a higher density with portions of a lower density, which can be produced by a single processing step, and whereby the product texture and surface shape/dimensions of the product are precisely controlled.

### SUMMARY OF THE INVENTION

The present inventors have found that a chewable article can be prepared from thermoplastic starch-based material through a one-step injection moulding process, and that such a product may facilitate improved mechanical interaction with the surface of the pet's teeth when chewed in comparison to solid, non-density-stratified or non-hardness-stratified products. The stratification in density or hardness, as the term is used herein, means that the product combines a hard or high density outer layer body portion with a soft or low density inner core body portion. A soft vs. a hard product portion may be obtained by foaming.

It is an advantage of the methods used in the preparation of a product in accordance with this invention that they result in a product of which the product specifications texture, shape, dimension and appearance are precisely controlled. For instance, the appearance of the pet chew product exhibits no uncontrolled blistering, and the products are stable in texture, shape, dimension and appearance, e.g. products of successive runs are essentially equal in texture, shape, dimension and appearance. Hence, the products provide i.a. high dimensional stability in product specifications.

It is an advantage of the methods for producing a pet chew product as disclosed herein that the shape, dimension and appearance are essentially in accordance with and/or maintain the specifications of the mould cavity. This is achieved by controlled opening of mould prior to complete setting of the injected product melt. Due to precise control over either or both the rate and the extent of opening of the mould cavity prior to product ejection, the duration of the cooling phase while the product is in contact with the mould plates is controlled. This allows for control of the rate of cooling and setting of the injected product melt, in particular the rate and/or extent of product expansion while the product is in contact with the mould plates. It also allows for control over the rate and/or extent of product expansion, and thereby, over the texture, shape, and dimension of the product. Finally, it allows for control over the appearance of the injection moulded product. Such appearance characteristics include, but are not limited to, roughness, gloss, depressions, blisters, etc. The product of the invention essentially acquires its surface, shape, dimension and appearance through reproduction of the inner surface of the metal mould and exhibits essentially no surface defects.

In producing injection moulded pet chew products based on starch mixtures of about 30-95 wt. %, preferably 40-89 wt. %, one of the challenges is to provide products with a sufficient size dimension such that it can be chewed on by pets. The size dimension of the combined core and skin forming the pet chew product body is preferably at least 6-7 mm, preferably 8-15 mm, such as 9, 10, 11, 12, 13, or 14 mm or more in thickness. Pet chews of such dimension having a soft and/or less dense core and a hard and/or more dense outer skin as foreseen in aspects of this invention are very difficult to produce, as the effect of rapid foaming upon injection, demixing, degradation phenomena and jetting of the material flow in the large moulding chamber results in severe product defects. It has now been found that an anti-prägen (mould decompression) step during the injection phase facilitates that product surface appearance is smooth and no foaming is apparent at the surface of the stratified product. In aspects of the present invention, a second anti-prägen step can be included during the cooling phase (i.e. after injection of the material to be moulded is completed, and optionally wherein cooling is applied to the mould). Anti-prägen during cooling is used to achieve foaming of the core material during cooling and results in the stratified (hard skin-soft core) product characteristics, and further facilitates the prevention of product deformation.

The terms “foamed” and “cellular” can be used interchangeably herein and refers to a material having a plurality of gas or air filled cells generally throughout the material. In order to produce a foamed or cellular material, the gas or air filled cells may be obtained by gas expansion of water present in the mixture, or by the use of other blowing agents as described herein.

The term “anti-prägen” as used herein refers to the process of mould decompression, comprising releasing the mould clamping force and allowing controlled and partial separation of the mould plates whereby the mould plates still exert at least some counter pressure on the injected material. In aspects of this invention, anti-prägen during the injection phase is preferably combined with anti-prägen during the cooling phase as described herein and can also be accomplished by controlled opening of the mould, preferably to a fixed partially opened position wherein the mould plates are at least partially separated. Preferably, in such embodiments of anti-prägen during the mould-injection step the mould is still not opened fully. Preferably, in embodiments of anti-prägen during injection, the increase in injected product volume exerts pressure on the preferably at least partially opened mould plates and the partially opened mould plates exert counter pressure on the molten shot being injected. In preferred embodiments, the mould is partially opened during the injection step at least partially, e.g. to about 1-15 mm, preferably about 1-10 mm, whereby during the partial opening of the mould (anti-prägen), injection of material is continued, preferably injection is continued until completion of the partial opening of the mould plates.

In aspects of this invention, the partial opening of the mould plates during injection of the molten material can be combined with partial opening of the mould plates during cooling of the molten shot, during which cooling step no additional material is injected into the mould. This second anti-prägen step, which occurs during cooling (i.e. the constraint cooling step as defined herein), allows the intermediate product to take up the larger volume of the mould, which expanded shape is then retained by setting of the material during cooling. The cooling may be performed for, e.g. 1-1000 seconds, preferably, 5-480 second, more preferably from about 10-300 seconds. This is sufficient to allow skin of the intermediate product to set, while allowing the molten core to expand upon release of moulding pressure, preferably upon at least partial opening of the mould (anti-prägen), whereby the separation between the mould plates is preferable between about 0.1-15 mm, more preferably 1-12 mm, still more preferably 1-10 mm.

The present inventors have found that suitable combined skin-core pet chews as presented herein can be produced with skin thickness of more than 0.5 mm, and an overall thickness of more than 5-6, or even 7, 8, 9, 10 mm or more, when the mould is allowed to partially open during the injection step, and preferably also during the cooling step. The starch based mixtures in such processes preferably comprise blowing agents as described herein to support the formation of the cellular core structure, wherein water in the mixture may serve as a blowing agent in this aspect. The products of the invention have a non-foamed appearance due to the presence of a non-foamed skin, and combine such a skin with a foamed or cellular core. The surface of the products is smooth, essentially without white stains (foaming), and mould details (aimed to provide surface patterns on the product) are accurately copied into the moulded product. The production of pet chews with such relatively large dimensions by injection moulding whereby the core of the material is allowed to expand by foaming expansion is also believed to reduce production cycle times, as the blowing agent expansion is believed to extract heat from the material, thereby adding the cooling process.

The present inventors have now discovered that expanded thermoplastic starch-based materials such as pet chews, preferably materials comprising a low amounts of protein (e.g. <4 wt. % of protein, based on the weight of the thermoplastic mixture), can very beneficially be produced by an injection moulding process, whereby, after the injection of the shot of thermoplastic melt and an initial cooling phase to allow formation of a solidified skin at the mould inner surface, the holding pressure in the mould cavity is released, and preferably the mould is opened partially, to allow the blowing agent in the non-cooled core of the injected thermoplastic melt to produce, by gas expansion, a foamed or cellular core body of a second density or hardness. The partially and controlled expanded product is then allowed to further cool and set while in contact with the non-pressurized and preferably partially opened mould. During this subsequent cooling phase, the product surface is maintained in contact with the mould by keeping the mould in the partially opened position, thereby providing a controlled cooling and setting process that results in an injection moulded thermoplastic starch-based product comprising a non-cellular skin of a first thermoplastic starch-based material enveloping a cellular core of a second thermoplastic starch-based material, the core having a density or hardness lower than the skin, and wherein the product texture, shape, dimension, and appearance are an accurate surface reproduction of the mould cavity. Subsequently, the product having stratified density can be ejected from the mould.

The product has at least high density and/or high hardness wall portion (skin) at which foaming expansion of the core material is constrained when the mould is at least partially opened and until the ejection step, where foaming expansion of the core material is allowed between the closed and partial opened position of the mould cavity, and wherein further foaming expansion of the core material and potential deformation of the product is prevented by cooling and/or setting of the core material prior to ejection of the finish formed product from the mould tool.

The partial opening step of the moulding process in accordance with this invention comprises withdrawing at least one moulding plate defining the cavity part of the mould tool from its closed position to a partial opened position to locally increase the volume of the cavity part to allow for foaming expansion of the thermoplastic material mixture to form the foamed core portion of the finished formed product. In aspects of this invention, at least a first partial opening step (anti-prägen) is included in the injection phase of the injection moulding process. Preferably, a second partial opening step (anti-prägen) is included the cooling phase of the injection moulding process. In the partial opening steps of the invention, in the injection or in the cooling phase are preferably such that material is constrained by the walls of the mould when the mould is at least partially opened. The material is constrained as used herein when it is in contact with the walls and the walls exert at least some pressure on the product. The product ejection step comprises opening the mould tool after the foamed core portion of the finished formed product has substantially solidified to shape.

The moulding tool that may be used in aspects of this invention preferably comprises at least two moulding plates defining a cavity when the mould tool is in its closed position, and defining an expanded cavity when the mould tool is in its partially opened position, which partially opened position is characterized by a gap between the at least two moulding plates, preferably a gap in the range of between 1 and 30 mm in width, wherein the expanded cavity is to be substantially reproduced in the skin portion of the finished formed product. The mould tool is preferably constructed so that a portion of the thermoplastics material mixture injected into the mould cavity solidifies at the cavity wall (i.e. the inner surface of the mould plates) before such material solidifies in the cavity center, so that the material in the cavity center can expand by foaming when at least one moulding plate is withdrawn from at least one other moulding plate defining the mould cavity, wherein the foaming expansion of the core material is at least partially constrained by the solidified skin, and/or wherein deformation of product shape and dimension is constrained or prevented at the inner surface of the expanded cavity when the mould tool is in its partially opened position. The thickness of the skin can i.a. be controlled by controlling the cooling and/or setting period of the thermoplastics material mixture in contact with the inner surface of the mould plates when in the closed and/or partially opened position.

In aspects of the present invention, the pet chew product is produced by injection moulding. The injection moulding process of the present invention is based on a single processing cycle, wherein the moulding process involves only a single closing and opening of the mould. Use can be made of co-injection of thermoplastic starch-based materials of different composition.

In one aspect, the present invention provides a pet chew product comprising a thermoplastic starch-based material, comprising an outer skin (or skin, as the terms can be used interchangeably herein) of a first thermoplastic starch material having a first density or hardness, enveloping an inner core of a second thermoplastic starch material having a second density or hardness that is lower than that of the outer skin.

The present invention provides a method for producing a pet chew product by a single injection molding cycle, comprising the steps of:

a) providing a thermoplastic starch mixture comprising 95-30 wt. % based on dry solid weight of the mixture of a starch or a starch derivative, 5-40 wt. % based on dry solid weight of the mixture of a plasticizer, and 0-30 wt. % based on dry solid weight of the mixture of a fibrous material;

b) converting said mixture into a thermoplastic starch-based melt by subjecting the mixture to a step wherein the starch is destructurized;

c) optionally mixing a blowing agent into the thermoplastic starch-based melt;

d) injecting the resulting thermoplastic melt comprising said optional blowing agent in a mould cavity while partially opening the mould during melt injection;

e) allowing the thermoplastic melt in contact with the mould cavity wall to at least partially cool and set thereby forming the outer skin of a first density or hardness;

f) partially opening the mould during melt cooling to allow gas expansion in the non-cooled core of the injected thermoplastic melt and formation of a foamed core of a second density or hardness;

g) allowing the melt to cool and set, and

h) ejecting the pet chew product from the mould cavity.

The present invention provides a method for producing a pet chew product by a single injection molding cycle, comprising the steps of:

a) providing a first thermoplastic starch mixture having a first density or hardness comprising 95-30 wt. % based on dry solid weight of the mixture of a starch or a starch derivative, 5-40 wt. % based on dry solid weight of the mixture, of a plasticizer, and 0-30 wt. % based on dry solid weight of the mixture of a fibrous material;

b) converting said first mixture into a first thermoplastic starch-based melt by subjecting the mixture to step wherein the starch is destructurized;

c) providing a second thermoplastic starch mixture having a second density or hardness, lower than the first mixture (i.e. densities or hardness of the mixture refers herein to density or hardness as determined following destructurization of the starch-based mixture into a thermoplastic melt an subsequent cooling of the melt to ambient temperatures and setting of the material), said second mixture comprising 95-30 wt. % based on dry solid weight of the mixture of a starch or a starch derivative, 5-40 wt. % based on dry solid weight of the mixture of a plasticizer, and 0-30 wt. % based on dry solid weight of the mixture of a fibrous material;

d) converting said second mixture into a second thermoplastic starch-based melt by subjecting the mixture to step wherein the starch is destructurized, and optionally adding a blowing agent to the mixture;

e) injecting the first and second melt in a mould cavity using a two shot or sandwich moulding process for combining the first and second thermoplastic starch melts in the mould cavity while partially opening the mould during melt injection, wherein the first thermoplastic melt is injected to be in contact with the mould cavity wall and wherein the second thermoplastic melt is injected with respect to the first thermoplastic melt so as to be enveloped by it, whereby the partial opening the mould during melt injection may be during the first and/or second melt injection, preferably during the second melt injection;

f) allowing the first and second melt to cool and set, optionally while partially opening the mould during the cooling step, and

g) ejecting the pet chew product from the mould cavity.

The present invention provides a method as described herein above, wherein the thermoplastic starch-based melt comprises a blowing agent selected from super critical fluids, carbonates, bicarbonates, nitrites, hydrides, peroxides, oxygen-containing acid derivatives, azo compounds, urea derivatives, hydrazines, semicarbazides, azides, N-nitroso compounds, and triazols, preferably bicarbonates.

The present invention provides a method as described herein above, wherein the step of partially opening the mould during the injection step comprises opening the mould for between 1-15 mm.

The present invention provides a method as described herein above, wherein the step of partially opening the mould during the cooling step comprises opening the mould for between 1-15 mm.

The present invention provides a method as described herein above, wherein the moisture content of the thermoplastic starch mixture or the first and second thermoplastic starch mixtures is conditioned to 5 to 20 wt. %, preferably from 6 to 15 wt. %, more preferably from 7 to 10 wt. %, based on the total weight of the thermoplastic starch.

The present invention provides an injection moulded pet chew product produced by a method as described herein above.

The present invention provides an injection moulded pet chew product as described herein above, whereby the pet chew is expanded as compared to a product produced with thermoplastic starch-based materials of the same composition in the same mould using the same method from which the step of partially opening the mould during melt injection has been omitted.

The present invention provides an injection moulded pet chew product as described herein above, whereby the pet chew is additionally expanded as compared to a product produced with thermoplastic starch-based materials of the same composition in the same mould using the same method, wherein the method of the product for comparison comprises step f) of claim 1, and wherein the method of the product for comparison does not comprise the step of partially opening the mould during melt injection.

The present invention provides an injection moulded pet chew product as described herein above, wherein the thickness of the product is at least 8 mm, or wherein the thickness of the skin is between 0.3-8 mm, preferably 2-8 mm.

The present invention provides an injection moulded pet chew product as described herein above, wherein the thermoplastic starch-based material(s) have a protein content of less than 4 wt. % based on dry solid weight of the mixture.

The present invention provides an injection moulded pet chew product as described herein above, wherein the difference in hardness between the skin and the core is between 1-50 Shore D hardness units, and preferably wherein the Shore D hardness of the skin is >22 and wherein the Shore D hardness of the core is <40.

The present invention provides an injection moulded pet chew product as described herein above, wherein the thermoplastic starch-based material(s) comprise an abrasive agent, preferably in particle form, preferably having a Mohs hardness of between 0.5 and 8, preferably between 1 and 7, preferably selected from the group consisting of carbonates, hydrated magnesium silicates, phyllosillicates, apatite-like materials, silica's, and combinations thereof, preferably wherein the abrasive agent is present in an amount of between 0 and 20 wt. %, based on the dry weight of the mixture.

The present invention provides an injection moulded pet chew product as described above, wherein the at least partial opening of the mould plates during the injection phase is the result of a partial separation of the mould plates for between 1-15 mm, and wherein the at least partial opening of the mould during the cooling phase is the result of a partial separation of the mould plates for between 1-15 mm.

The present invention provides an injection moulded pet chew product comprising a skin of a first thermoplastic starch-based material enveloping a core of a foamed or cellular second thermoplastic starch-based material, wherein the first and second thermoplastic starch-based materials may be the same or different and comprise 30-95 wt % of a starch or a starch derivative, based on dry solid weight of the material, the core having a density or hardness lower than the skin, wherein the pet chew product is produced by foaming expansion of the core under constrained cooling conditions by at least partial opening of the mould during both the injection phase and the cooling phase of the injection moulding process, and whereby the pet chew is additionally expanded as compared to a product produced with said thermoplastic starch-based materials in said mould by foaming expansion of the core under constrained cooling conditions only by said at least partial opening of the mould during the cooling phase of the injection moulding process.

In a preferred embodiment, the foaming expansion of the core material is constrained at the skin when the mould for injection moulding is at least partially opened until the ejection step, where foaming expansion of the core material is allowed between the closed and partial opened position of the mould cavity during injection phase and cooling phase of the injection moulding process, and wherein further foaming expansion of the core material and potential deformation of the product is prevented by cooling and/or setting of the core material prior to ejection of the finish formed product from the mould tool and/or by counter pressure from the mould tool.

In another aspect, the invention provides a method for producing a pet chew product by a single injection molding cycle, comprising the steps of:

a) providing a thermoplastic starch mixture comprising 95-30 wt. %, preferably 89-40 wt. %, based on dry solid weight of the mixture, of a starch or a starch derivative, 5-40 wt. %, preferably 10-35 wt. %, based on dry solid weight of the mixture, of a plasticizer, and 0-30 wt. %, preferably 1-25 wt. %, based on dry solid weight of the mixture, of a fibrous material, preferably consisting of fibers having a length of between 23 and 2000 μm;

b) converting said mixture into a thermoplastic starch-based melt by subjecting the mixture to a step wherein the starch is destructurized, preferably by extrusion;

c) optionally mixing a blowing agent into the thermoplastic starch-based melt;

d) injecting the resulting thermoplastic melt comprising said optional blowing agent in a mould cavity under simultaneous partial opening of the mould;

e) allowing the thermoplastic melt in contact with the mould cavity wall to cool and set thereby forming the outer skin of a first density or hardness;

f) releasing the holding pressure in the mould cavity to allow the blowing agent in the non-cooled core of the injected thermoplastic melt to produce, by gas expansion, a foamed or cellular core body of a second density or hardness;

g) allowing the melt to cool and set, and

h) ejecting the pet chew product from the mould cavity,

wherein step f) is performed by releasing the mould clamping force resulting in controlled and partial separation of the mould plates.

In another aspect, the invention provides a method for producing a pet chew product by a single injection molding cycle, comprising the steps of:

a) providing a first thermoplastic starch mixture having a first density or hardness comprising 95-30 wt. %, preferably 89-40 wt. %, based on dry solid weight of the mixture, of a starch or a starch derivative, 5-40 wt. %, preferably 10-35 wt. %, based on dry solid weight of the mixture, of a plasticizer, and 0-30 wt. %, preferably 1-25 wt. %, based on dry solid weight of the mixture, of a fibrous material;

b) converting said first mixture into a first thermoplastic starch-based melt by subjecting the mixture to step wherein the starch is destructurized, preferably an extrusion step;

c) providing a second thermoplastic starch mixture having a second density or hardness, lower than the first mixture, said second mixture comprising 95-30 wt. %, preferably 89-40 wt. %, based on dry solid weight of the mixture, of a starch or a starch derivative, 5-40 wt. %, preferably 10-35 wt. %, based on dry solid weight of the mixture, of a plasticizer, and 0-30 wt. %, preferably 1-25 wt. %, based on dry solid weight of the mixture, of a fibrous material;

d) converting said second mixture into a second thermoplastic starch-based melt by subjecting the mixture to step wherein the starch is destructurized, preferably an extrusion step;

e) injecting the first and second melt in a mould cavity using a two shot or sandwich moulding process for combining the first and second thermoplastic starch melts in the mould cavity, wherein the first thermoplastic melt is injected to be contact with the mould cavity wall and wherein the second thermoplastic melt is injected with respect to the first thermoplastic melt so as to be enveloped by it, whereby during the injection of the first and/or second melt in the mould cavity occurs under simultaneous partial opening of the mould;

f) allowing the first and second melt to cool and set under further partial opening of the mould, and

g) ejecting the pet chew product from the mould cavity.

In a preferred embodiment of this method, a blowing agent can be included in the second thermoplastic starch mixture, whereby an anti-prägen step as defined herein can be used to allow the formation of a foamed core.

In a preferred embodiment of this aspect, step f) is performed by “anti-prägen” (releasing the mould clamping force resulting in controlled and partial separation of the mould plates). Anti-prägen can be accomplished by controlled opening of the mould, preferably to a fixed partially opened position wherein the mould plates are at least partially separated. Preferably, in such embodiments the mould is still not opened fully. Preferably, in such anti-prägen embodiments, the expanding product exerts counter pressure on the preferably at least partially opened mould plates. In other preferred embodiments, the mould is opened at least partially, e.g. to about 1-3 mm, preferably upon cooling of the molten shot for a short period of time, e.g. 1-1000 seconds, preferably, 5-400 second, more preferably from about 10-300 seconds. This is sufficient to allow skin of the intermediate product to set, while allowing the molten core to expand upon release of moulding pressure, preferably upon at least partial opening of the mould, whereby the separation between the mould plates is preferable between about 0.1-15 mm, more preferably 1-12 mm, still more preferably 1-10 mm.

Alternatively, this procedure of partially opening mould plates (anti-prägen) may be performed by using a first and second thermoplastic starch mixture, wherein the first mixture is injected and allowed to cool and set, preferably allowed to cool and set at least partially, to thereby provide a high density skin of a pet chew product in accordance with the present invention as a reproduction of the mould inner surface, and then injecting the second mixture, while releasing the mould pressure and/or preferably at least partially opening the mould, to thereby allow the second mixture to at least partially expand in the core of the (at least partially) set skin and allowing the combined mixtures to cool and set, and then opening the mould to eject the product.

The term “constrained cooling”, as used herein, means that during the cooling phase of the production process, the thermoplastic starch based pet chew product stays in maximal contact with the mould over the entire dimension of the product (e.g. over the entire product surface) to ensure a proper and efficient cooling process, and to ensure that control is maintained over the texture, shape, dimension and appearance of the product. Hence, the constrained cooling conditions are preferably applied in such way that the product has well defined and reproducible shape, appearance (homogenous surface texture) and dimension specifications. Preferably, product-to-product variability in dimension and/or shape is less than 10%, preferably, less than 5%, more preferably, less than 4, 3, 2, or 1%, preferably less than 0.5%, based on the statistical variation in shape and/or dimension (size parameters) of the product. The product of the invention, following its ejection form the mould, preferably does not require any post-moulding processing, such as trimming, or de-flashing for removal of excess material. Constrained cooling herein includes constrained foaming expansion of the core material when the mould is at least partially opened, where foaming expansion of the core material is allowed between the closed and partial opened position of the mould cavity, and wherein further foaming expansion of the core material and potential deformation of the product is prevented by cooling and/or setting of the core material prior to ejection of the finish formed product from the mould tool and/or by counter pressure from the mould tool, i.e. wherein the foaming expansion of the core material is at least partially constrained by the solidifying or solidified skin, which deformation in turn is constrained over essentially the entirety of the product surface by the inner surface of the expanding or expanded mould cavity when the mould tool moves into or is in its partially opened position (e.g. by anti-prägen as described herein).

In a further alternative embodiment of a method for producing a pet chew product according to the present invention, a method for producing a pet chew product according to the invention by a single injection molding cycle, is provided, which embodiment comprises the steps of:

a) providing a first thermoplastic starch mixture having a first density or hardness comprising 95-30 wt. %, preferably 89-40 wt. %, based on dry solid weight of the mixture, of a starch or a starch derivative, 5-40 wt. %, preferably 10-35 wt. %, based on dry solid weight of the mixture, of a plasticizer, and 0-30 wt. %, preferably 1-25 wt. %, based on dry solid weight of the mixture, of a fibrous material;

b) converting said first mixture into a first thermoplastic starch-based melt by subjecting the mixture to a step wherein the starch is destructurized, preferably an extrusion step;

c) providing a second thermoplastic starch mixture having a second density or hardness, lower than the first mixture, said second mixture comprising 95-30 wt. %, preferably 89-40 wt. %, based on dry solid weight of the mixture, of a starch or a starch derivative, 5-40 wt. %, preferably 10-35 wt. %, based on dry solid weight of the mixture, of a plasticizer, and 0-30 wt. %, preferably 1-25 wt. %, based on dry solid weight of the mixture, of a fibrous material;

d) converting said second mixture into a second thermoplastic starch-based melt by subjecting the mixture to a step wherein the starch is destructurized, preferably an extrusion step;

e) injecting the first and second melt in a mould cavity using a two shot or sandwich moulding process for combining the first and second thermoplastic starch melts in the mould cavity, wherein the first thermoplastic melt is injected to be in contact with the mould cavity wall and wherein the second thermoplastic melt is injected with respect to the first thermoplastic melt so as to be enveloped by it;

f) allowing the first and second melt to cool and set, and

g) ejecting the pet chew product from the mould cavity.

Due to the characteristics of the injection moulding process specific non-cellular textures, in particular of the skin of the pet chew product, can be realized.

In another aspect, the present invention provides an injection moulded pet chew product as described herein before, wherein the at least partial opening of the mould plates during the injection phase is the result of a partial separation of the mould plates for between 1-15 mm, and wherein the at least partial opening of the mould during the cooling phase is the result of a partial separation of the mould plates for between 1-15 mm.

Alternatively, or in combination, the first thermoplastic starch-based melt does not comprise a blowing agent. This prevents the formation of foamed bodies having an intrinsically lower density or hardness.

In alternative or further embodiments of methods of the invention, the thermoplastic starch mixture or the first and second thermoplastic starch mixtures are converted into a thermoplastic starch melts by extrusion at a temperature of from 95 to 180° C., preferably from 100 to 150° C.

The thermoplastic starch mixtures of the present invention comprise moisture. This moisture itself may act as a blowing agent in aspects herein. The addition of an additional blowing agent is optional. In alternative or further embodiments of methods of the invention, the moisture content of the thermoplastic starch mixture or the first and second thermoplastic starch mixtures may be conditioned to 5 to 20 wt. %, preferably from 6 to 15 wt. %, more preferably from 7 to 10 wt. %, based on the total weight of the thermoplastic starch.

In methods for producing the pet chew product of the present invention by injection moulding, the thermoplastic starch is preferably moulded by injection moulding at a temperature ranging from 80 to 200° C., preferably from 110 to 170° C.

In another aspect, the present invention provides a pet chew product produced by the method of the invention.

In another aspect, the present invention provides an injection moulded pet chew product comprising a skin of a first thermoplastic starch-based material enveloping a core of a second thermoplastic starch-based material, wherein the first and second thermoplastic starch-based materials may be the same or different, the core having a density or hardness lower than the skin, wherein the pet chew product is produced in a single injection moulding cycle using a first mould decompression step during the injection phase and a second mould decompression step during the cooling.

In a preferred embodiment of this aspect, the skin comprises a non-cellular thermoplastic starch-based material, and wherein the core comprises a foamed or cellular thermoplastic starch-based material.

In another preferred embodiment of this aspect, the first, second or both thermoplastic starch-based materials have a protein content of less than 4 wt. % based on the total weight of the starch.

In another preferred embodiment of this aspect, the pet chew has a thickness of at least 10 mm. The thickness herein being defined as the smaller of the dimensions length, width, and thickness of the pet chew.

In another preferred embodiment of this aspect, the difference in hardness between the skin and the core is between 1-50 Shore D hardness units, and preferably wherein the Shore D hardness of the skin is >22 and wherein the Shore D hardness of the core is <40.

In another preferred embodiment of this aspect, the composition of the first and/or second thermoplastic starch materials comprise 95-30 wt. %, preferably 89-40 wt. %, based on dry solid weight of the composition, of a starch or a starch derivative, 5-40 wt. %, preferably 10-35 wt. %, based on dry solid weight of the composition, of a plasticizer, and 0-30 wt. %, preferably 1-25 wt. %, based on dry solid weight of the composition, of a fibrous material, preferably consisting of fibers having a length of between 23 and 2000 μm.

In another aspect, the present invention provides a method of cleaning teeth of a pet, the method comprising administering to the pet an edible pet chew according to the present invention.

### DESCRIPTION OF THE DRAWINGS

FIG. 1 shows details of a section of a partly cellular injection moulding product according to the invention (A), and a cellular product made with help of microwave heating (B) prepared in accordance with methods as inter alia described in U.S. Pat. No. 6,180,161.

FIG. 2 shows overall appearance of an injection moulded product having a cellular core as produced in Example 2. Cross Section along flow direction (A), cross section along flow direction (higher magnification) (B), cross section perpendicular to flow direction (C).

FIG. 3 shows overall appearance of an injection moulded product having a cellular core as produced in Example 3. Cross Section along flow direction (A), cross section along flow direction (higher magnification) (B), cross section perpendicular to flow direction (C).

FIG. 4 shows overall appearance of an injection moulded product having a dense non-cellular core as produced in Example 4. Product overview (A), cross perpendicular to flow direction (B).

FIG. 5 shows overall appearance of an injection moulded products as produced in Example 5. A-C: Sample 5-1: Anti-Pragen: free distance. Cross Section along flow direction (A), cross section along flow direction (higher magnification) (B), cross section perpendicular to flow direction (C). Sample is irregular in shape and size. The skin is irregular in thickness. D-F: Sample 5.2: Anti-Pragen max 3 mm. Cross Section along flow direction (D), cross section along flow direction (higher magnification) (E), cross section perpendicular to flow direction (F). Material is rather regular in shape and size. The outside layer is rather regular in thickness. G-I: Sample 5.3: Anti-Pragen max 2 mm. Cross Section along flow direction (G), cross section along flow direction (higher magnification) (H), cross section perpendicular to flow direction (I). Material is maximal regular in shape and size. The outside layer is completely regular in thickness.

FIG. 6 shows overall appearance of an injection moulded products as produced in Example 6. A-B: Sample 6-1: Material composition A without chemical blowing agent; no anti-prägen. Interior is not expanded. The outside of the sample product is regularly shaped. C-D: Sample 6-2: Material composition A without chemical blowing agent; anti-prägen, but not limited (free way); Interior is slightly expanded due to moisture/steam expansion; The outside of the sample is irregularly shaped. E-F: Sample 6-3: Material composition A with chemical blowing agent; anti-prägen, max 2 mm; Interior is highly and homogeneously expanded due to the chemical blowing agent; the outside of the sample is regularly shaped.

FIGS. 7A and 7B show the appearance of an injection moulded products as produced in Example 8, test series 8-1, where the anti-prägen function was not active during the injection and cooling phase. Products of test series 8-1 have a somewhat foamy appearance (white spots on the surface) and product details are somewhat vague. FIGS. 7C and 7D show the overall appearance and thickness of products as produced in Example 8, test series 8-2, respectively. In series 8-2, anti-prägen function was active during the injection phase, but not during the cooling phase. Products of test series 8-2 have a more homogeneous appearance (without white spots). In 8-2, mould details are accurately copied into the moulded product.

FIGS. 8A and 8B show the thickness and the cross-sectional appearance of a product produced in Example 9, test series 9-1, respectively. Anti-prägen function was active during the injection phase, but not during the cooling phase. Products of test series 9-1 consist of solid, non cellular products. FIGS. 8C and 8D show the thickness and the cross-sectional appearance of a product produced in Example 9, test series 9-2, respectively. In 9-2, the anti-prägen function was active during both the injection phase and the cooling phase. Products of series 9-2 consist of a skin-core product, in which the skin consist of a non-cellular material and the core consist of a homogeneous foamed material. In 9-2, the (outer) shape and dimensions are smooth and regular (no blisters). In FIG. 8D, the upper product is a product of test series 9-1, and the lower product is of test series 9-2.

FIG. 9A shows the cross-sectional appearance of a product as produced in Example 10, test series 10-1. Anti-prägen function was active during the injection phase, but not during the cooling phase. FIG. 9B shows the cross-sectional appearance of a product as produced in Example 10, test series 10-2. In series 10-2, anti-prägen function was active during both the injection phase and the cooling phase. Products of product series 10-1 consist of skin-core and non cellular structure. Products of product series 10-2 consist of a skin-core product, in which the skin consist of a non-cellular material and the core consist of a homogeneous foamed material. In products of 10-2, (outer) shape and dimensions are smooth and regular (no blisters). In addition, mould details are accurately copied into the moulded product.

FIG. 10 shows the thickness and the cross-sectional appearance of a representative B1 test product (panel A), and a representative B2 reference product (panel B), as well as the length (ca. 20 cm) of both products (panel C, wherein B1-test product is top and B2 reference product is bottom) as used in Example 11.

FIG. 11 shows the average consumption of the B1-test product (bottom line) and B2-reference product (top line) as described in Example 12.

FIG. 12 shows the teeth of one of the dogs receiving the B1-test product of the invention as described in Example 12 with dental-plaque-disclosing agent after 0 days (panel A), 14 days (panel B) and 28 days (panel C).

### DETAILED DESCRIPTION OF THE INVENTION

Thermoplastic starch has very beneficial material characteristics, making it very suitable for the production of edible pet chews. Essentially, materials with a variety of densities and hardness values can be produced depending on the amount of fiber and the amount of plasticizer used. Although fiber is not necessary for preparing a soft and low density material, it is preferred that fiber is present at least in the outer skin. Hence, the material is very suited for producing pet chews of different densities and hardness values.

It is an advantage of a pet chew product of the present invention that the specific combination of a hard thermoplastic starch with a soft thermoplastic starch comes very close to the natural diet of the pet. After all, the wild ancestors of our modern pets did not eat processed foods. They ate natural materials comprising combinations of hard and soft elements. Especially the carnivorous animals, would spend much time shredding soft tissue from hard bones. This natural diet has a tendency to clean the teeth of the animal by a mechanical cleaning action.

It is another advantage of a pet chew product of the present invention that the specific combination of a hard thermoplastic starch with a soft thermoplastic starch provides a hard sin with a soft core, wherein the thickness of the skin is adapted to allow piercing or fracturing by a pet's teeth when chewed. This allows penetration of the teeth whereby the outer layer will fracture, break or rupture when chewed, resulting in indentations or cavities in the hard outer skin having the profile of the pet's teeth. The soft core allows further penetration of the teeth into the underlying material and the resulting friction between tooth surface and pet chew skin results in strong mechanical interaction with the surface of the pet's teeth over its entire length. A pet chew product of the present invention is therefore very effective in removing plaque, or even tartar and stain from the teeth of an animal, even at the difficult-to-reach locations at the base of the teeth.

Chewable articles for pets such as dogs are well known in the art. These articles are of a flexible nature and serve as a toy for the pet as well as a means of keeping the pet's dentures in good condition. This type of article can be manufactured of different materials. Mainly, they can be divided in non-edible and edible variants. Most edible pet chews are based on starch, protein, or mixtures thereof.

U.S. Pat. No. 6,379,725 and WO 01/45517 disclose protein-based products.

U.S. Pat. No. 5,827,565 discloses a dog chew based on a thermoplastic potato starch.

US 2003/168020 discloses starch containing pet chews wherein mixtures comprising wheat flour, rice flour or tapioca flour in combination with a small amount of extra protein are extruded.

It is a feature of the product of the present invention that it combines a hard or dense skin (i.e. a skin portion having a higher density or hardness than the core portion) with a soft or cellular core (i.e. a core having a lower density or harness than the skin portion). Nonetheless, the product is preferably prepared in a single processing cycle. This means that, now that the product is based on thermoplastic starch, the skin and core are preferably fused and inseparable. Moreover, the density or hardness of skin and core differ. Yet, the skin and core are preferably cooled together and form a single product matrix. This facilitates that the cracked or fractured hard skin remains attached to the product as it is chewed by the pet. These hard skin fragments provide mechanical cleaning to the surface of the pet's teeth.

A single processing cycle, as defined herein, refers to a process wherein the skin and core are produced through a mechanical manufacture process using a piece of manufacture equipment that receives thermoplastic starch mixture(s) for skin and core at one and, and provides ready, finalized cooled products at another end using a single melting and cooling cycle. Examples of single processing cycles include moulding process involving only a single closing and opening of the mould.

A pet's chew according to the invention is based on starch. In principle, the starch may be of any origin. Suitable examples are potato, wheat, corn, tapioca, rice and pea starches. The starch can be used in native form, but may also be physically or chemically modified. Of course, it is also possible to use combinations of native starch and modified starch, or combinations of different modified starches. Chemically modified starches which may be used are oxidized starches, carboxymethylated starches, hydroxyalkylated starches, acetylated starches, (partially) hydrolysed starches, and other derivatized starches. An example of a suitable physically modified starch is a starch which has been subjected to ion exchange with, for instance, sodium or potassium ions.

The mixture that is to be converted into a thermoplastic starch according to the invention preferably comprises an amount of 30-95 wt %, preferably from 40-89 wt % based on dry solid weight of the mixture of a starch or a starch derivative.

A preferred example of a modified starch is a starch hydrolysate. This is a native (or already otherwise modified) starch which has been subjected to a partial chemical or enzymatic hydrolysis. The extent of hydrolysis can be expressed in terms of the dextrose equivalent (DE). Starch which has not been subjected to hydrolysis has a DE of 0, whereas a completely hydrolysed starch has a DE of 100. In order to improve the flowing characteristics of a mixture from which a thermoplastic starch is prepared according to the invention, it is preferred to incorporate a starch hydrolysate having a DE up to 40, more preferably between 1 and 20. It has been found that the use of a partially modified starch in the preparation of a pet's chew according to the invention results in a product having superior characteristics.

The molecular mobility of the mixture to be converted into a thermoplastic starch is increased by usage of starch hydrolysates), leading to an improved relaxation of the stress present in the material. As a result an increased dimensional stability in conjunction with an improved flexibility are achieved.

If desired, the starch may be mixed with other natural and biodegradable polymers such as cellulose and derivatives thereof, proteins such as zein or wheat proteins, or other polysaccharides such as gums (Arabic gum, guar gum and the like), pectin, or dragant. It is also possible to use a natural mixture of starch and proteins, such as flour, as a starting material.

The mixture that is to be converted into a thermoplastic starch according to the invention preferably comprises an amount of less than 10 wt. %, preferably less than 5 wt. %, even more preferably less than 4, 3, 2, or 1 wt. % of protein based on dry solid weight of the mixture, preferably based on the dry weight of the starch material. It is a preferred embodiment in aspects of this invention that the mixture that is to be converted into a thermoplastic starch is essentially free of protein.

In order to prepare a pet's chew of a starch material according to the invention, the starch is first converted into a thermoplastic starch melt. To that end, a mixture of the starch with suitable additives is prepared, which mixture is then preferably subjected to extrusion in order to destructurize the starch in the mixture.

The starch used in aspects of this invention is destructurized, preferably by extrusion.

In aspects of this invention, the starch or starch derivative is mixed with a plasticizer. Although water also has plasticizing qualities in a process of producing a pet's chew according to the invention, an additional plasticizer is present in the starch mixtures in aspects of this invention. A preferred class of plasticizers is the class of polyols. This class comprises, amongst others, glycol, diethylene glycol, alkylene glycols, polyalkylene glycol, sorbitol, glycerol, glycerol mono-esters, and the like. Other suitable classes of plasticizers include esters of citric acid, and urea. The amount of plasticizer that is preferably present in the starting mixtures to prepare a pet's chew according to the invention is from 5-40 wt. %, preferably from 10-35 wt. %, based on the dry solid weight of the mixture. It has been found that these amounts of plasticizer lead to a very flexible product, while the dimensional stability of the final product, the pet's chew, is not endangered.

The amount of water that is preferably present in the starting mixture to prepare a pet's chew according to the invention is from 7 to 35 wt. %, based on dry solid weight of the mixture.

The mixture may further comprise other additives such as an emulsifier. Suitable examples of emulsifiers include lecithin and monoglycerides. An emulsifier will be preferably be present in an amount of from 0 to 5 wt. %, based on dry solid weight of the mixture.

Flow property enhancers/lubricants result in an increased processability (products with lower stress) of the thermoplastic starch. Examples of flow property enhancers are animal and vegetable oils and fats, especially hydrogenated oils and fats, and fatty acids and fatty acid derivatives such as mono- and diglycerides, fatty acid amides, metal salts and sorbitanesters of these fatty acids. Also fosfatides can be used as flow property enhancer. Ricinus oil and lecithin are examples of flow property enhancers/lubricants with a particular good performance. The amount of flow property enhancer in the mixture to be converted to a thermoplastic starch can be up to 10 wt. %, more preferably between 0 and 5 wt. % based on dry solid weight.

A further suitable, but optional ingredient in the mixture is a fiber. Preferably, a pet food-grade fibrous material of natural origin is used. Preferred examples include cellulose, hemp, coconut, grass, flax, potato and other natural fibers. The fibers preferably have a length between 23 and 2000 μm, more preferably between 60 and 300 μm. The amount in which the fiber is preferably used is chosen in the range of from 0-30 wt. %, preferably from 1-25 wt. % based on dry solid weight of the mixture of a fibrous material.

A further suitable, but optional ingredient in the mixture is an abrasive agent. Preferably, the abrasive agent is in particle form. In order to have abrasive effect on the teeth of pets, the abrasive agent preferably has a Mohs hardness of between 0.5 and 8, preferably between 1 and 7, preferably selected from the group consisting of calcium carbonate or other carbonates, hydrated magnesium silicates, phyllosillicates, apatite like materials and/or various silica's. Other possibilities for abrasive agents are sodium alginate, powdered cellulose, cellulose fibers, pyrophosphates, and combinations thereof, preferably wherein the abrasive agent is present in an amount of between 0 and 20 wt. %, based on the dry weight of the mixture.

It is further possible to incorporate an organic or inorganic filler material, such as chalk or titanium oxide. A filler is preferably added in an amount of from 0 to 10 wt. %, based on the weight of dry solid mixture.

Other additives, such as pH regulators, health ingredients, vitamins coloring agents, enzymes, aromas or palatability enhancers can also be incorporated at this stage. For example, as pH regulator sodium bicarbonate or a phosphate buffer can be used. As health ingredients, vitamins or conjugated linoleic acid (CLA) can be used. As aroma or palatability enhancer, chicken, beef, or vegetable (e. g. mint or vanilla) aromas are often employed. As coloring agents, red, yellow, orange (iron oxide), green (chlorophyll) or white (titanium oxide) colorants are often employed. Typically, these additives will be added in an amount in the range of from 0 to 10 wt. %, based on dry solid weight of the mixture.

In order to prepare a thermoplastic starch of the above described mixture, it is preferably subjected to an extrusion step. During the extrusion, the starch will be gelatinized or destructurized. It is preferred to use a twin-type extruder operated at a temperature of from 95 to 180° C., more preferably from 100 to 150° C. As the mixture will undergo a thorough homogenisation during extrusion, it is not of crucial importance that all ingredients of the mixture are mixed so rigorously as to obtain a homogeneous mixture prior to extrusion. During the extrusion, the starch will be converted from a ordered structure into an unordered, amorphous structure (destructurizing), which yields a thermoplastic, very well processable material or melt.

In aspects of the present invention, it is preferred that a single injection mould cycle step, defined herein as a single processing cycle, is a final stage production cycle that follows the production of an intermediate granulate, wherein the granulate for the inner core and outer skin may be the same or different.

When preparing foamed inner cores in aspects of this invention, use can be made of a blowing agent (e.g. a super critical fluid (SCF), gas (e.g. nitrogen) or other blowing agent) that is mixed with the thermoplastic starch melt during or after extrusion, but prior to injection moulding, and a microcellular structure is created during injection moulding in the core of the product by gas expansion in the moulding cavity. A suitable process is the MuCell® process (Trexel, Inc., Wilmington, Mass. 01887 USA), wherein a single phase solution of thermoplastic melt and blowing agent is created by injecting the blowing agent into the thermoplastic melt during screw recovering of the extruded melt, and whereby the blowing agent is subsequently fully dissolved into the melt by mixing. Formation of the foamed inner core occurs during injection into the mould, whereby low pressure in the mould causes the blowing agent to form cells that grow in size until the material cools and sets or the mould cavity is full.

Another suitable blowing agent for use in aspects of this invention is water, or moisture, intrinsically present in the thermoplastic starch based mixtures. Moisture present in the mixture may suitably be used as a blowing agent when injection temperatures during injection moulding above 110° C. are used. In aspects of this invention injection moulding temperatures are usually about 130° C.

Highly preferred blowing agents include chemical blowing agents. Chemical blowing agents are organic and inorganic compounds that decompose thermally into gases not reacting with the polymer matrix. This process is usually exothermic and irreversible; however, certain compounds that decompose through thermal dissociation, such as bicarbonates, evolve gas in a reversible and endothermic reaction. The characteristic property of these compounds is their decomposition temperature, which determines their practical use as blowing agents for a given thermoplastic material and for its processing conditions. Chemical blowing agents may be based on carbonates and bicarbonates, nitrites, hydrides, peroxides, oxygen-containing acid derivatives, azo compounds, urea derivatives, hydrazines, semicarbazides, azides, N-nitroso compounds, and triazols. Highly preferred blowing agents in aspects of this invention are sodium bicarbonate based additives (e.g PlastronFoam®), for instance PlastronFoam F01-17 (Plastron SAS, France). The blowing agent is preferably food grade. Blowing agents may be added in an amount od between 0.01-10 wt. %, preferably 0.5-2 wt. %, more preferably about 1 wt. %, based on the weight of the mixture, and may be added to the mixture by dry blending.

In aspects of this invention, the pet's chew is moulded by injection moulding. The starting thermoplastic starch mixture (suitable for producing the first and second melts in aspects of this invention) is preferably conditioned to a moisture content of from 5 to 20 wt. %, more preferably from 6 to 15 wt. %, even more preferably from 7 to 10 wt. %, based on the weight of the mixture.

The moisture content can be controlled by using a vacuum zone in the extruder for preparing the mixture or by drying the mixture with hot air, a blowing agent can be added thereafter if needed.

During injection moulding, it is preferred to employ a processing temperature ranging from 80 to 200° C., more preferably from 110 to 170° C. If no, or not all additives like vitamins, coloring agents, aromas or taste enhancers have been added prior to extrusion, they can also be added to the thermoplastic starch granulate directly prior to injection moulding.

The injection moulding is preferably performed using a pressure in the barrel of the apparatus of below 2000 bar. The rate of injection is preferably kept relatively low and the injection channels are preferably relatively wide in order to keep the shear, that the material is exposed to, low.

In methods comprising injection molding, the skilled person will appreciate that thermoplastic starch exposed to temperatures in excess of 100° C. will have an inherent tendency to foam as it contains a certain amount of moisture. The moisture or water can serve as a blowing agent. In order to make use of this phenomenon in injection moulding, the material should be allowed to produce a foam. This means that the water in the material must be allowed to undergo gas expansion. As long as a thermoplastic starch material with a temperature over 100° C. is maintained under pressure, no foam will be formed. During the injection of the thermoplastic starch material in the mould, pressure is therefore preferably maintained. When the mould cavity is completely filled, the injected material will take a certain period before it is completely cooled and set, starting from the walls of the mould inward. At a certain time point prior to complete cooling, the temperature in the material in the mould ranges from a cooled outer layer to an inner layer that is still warm. If the mould cavity is opened for a small distance during cooling (anti-prägen) the outer layer will be unable to withstand the internal pressure, which exists in the (hot) core of the injected mass; the material will have the opportunity to produce a foam by gas expansion. This process can be further supported by the aid of an additional (gaseous) blowing agents, for instance in the form of a gas, including, but not limited to CO₂ and N₂, as described above. CO₂ can suitably be in added in preferred amounts of 0-5%; N₂ can suitably be in added in preferred amounts of 0-3%, based on the volume of the mould.

Modification of the injection moulding process may lead to an improved dimensional stability of the final product. In order to achieve this, the process should be designed in such a way that the lowest amount of stresses is frozen in the matrix. This can be realized by increasing the processing temperature, by using low backpressure profiles and using high mould temperatures, in combination with a low injection speeds. As a result, cycle times will increase.

The mould into which the starch melts are injection moulded, preferably has the shape of a conventional dog chew, such as the form of a bar, stick, or a hollow or other natural shape, for instance mimicking the shape of a bone. Other shapes that are contemplated are of a marrow bone, pig's ear, tooth brush, or a combination of shapes such as a dog chew which is shaped like a bone on one side and like a tooth brush on the other. The final product is preferably packaged in a water, moisture and air proof packaging material.

It is to be noted that it is contemplated that the above described embodiment of injection moulding may be preceded by extrusions steps, for instance by making use of a twin-screw extruder mounted on an injection moulding apparatus.

The pet chew product according to the present invention can be described by its hardness parameters. The pet chew product of the present invention combines a hard material on the outside with a softer material on the inside. The hardness of both the outer skin and inner core is suitably expressed in Shore D-scale (measured according to ISO 7619 and/or 868, preferably ISO 868).

Under the definition of the present invention, a hard outer skin may have a hardness higher than 22 Shore D, such as 25, 30, 35, 40, 45, 50, 55, 60, 65, 70 or 75 whereas a soft inner core may have a hardness lower than 30 Shore D, such as 25, 20, 25, 10, or 5. The shore D hardness of the outer skin may be in the range of 22-75, preferably 22-50, more preferably 25-30, while the shore D hardness of the inner core may be in the range of 5-30, preferably 15-25, more preferably 18-22. Although the above ranges overlap, the hardness of the inner core is lower than that of the outer skin. Preferably, the difference in hardness between the outer skin and the inner core may be between 1 and 30 Shore D hardness units, more preferably between 10 and 20 Shore D. The difference in hardness between the outer skin and the inner core may be between 1-10 Shore D hardness units, wherein the Shore D hardness of the outer skin is preferably >22 and wherein the Shore D hardness of the inner core is preferably <30.

Alternatively, under the definition of the present invention, a hard outer skin may have a hardness higher than 22 Shore ID, such as 25, 30, 35, 40, 45, 50, 55, 60, 65, 70 or 75 whereas a soft inner core may have a hardness lower than 40 Shore D, such as 35, 30, 25, 20, 25, 10, or 5. The shore D hardness of the outer skin may be in the range of 22-75, preferably 22-50, more preferably 25-30, while the shore D hardness of the inner core may be in the range of 5-40, preferably 15-37, more preferably 18-35. Although the above ranges overlap, the hardness of the inner core is lower than that of the outer skin. Preferably, the difference in hardness between the outer skin and the inner core may be at least between 1 and 50 Shore D hardness units. The difference in hardness between the outer skin and the inner core may be between 1-40 Shore D hardness units, wherein the Shore D hardness of the outer skin is preferably >22 and wherein the Shore D hardness of the inner core is preferably <40.

The invention will now be further elucidated by the following, nonrestrictive examples.

### EXAMPLES

### General

### Production of a Thermoplastic Starch Granulate.

A powder/fluid mixture according to various specified formulations (see table 1) were extruded on a Buhler Twin Screw extruder DNDF-93 (L/D=48) extruder (12 barrel elements). The temperature profile along the barrel was: zone 1: 15-25° C.; zone 2: 15-25° C.; zone 3: 115-120° C.; zone 4: 135-145° C.; zone 5: 135-145° C.; zone 6: 100-105° C.; zone 7: 95-105° C.; zone 8: 70-90° C.; zone 9: 60-90° C. (incl. vacuum); zone 10: 60-90° C.; zone 11: 60-90° C. (incl. vacuum); zone 12: 50-60° C. Set point of the die temperature was 85-95° C. Screw speed was 125 rpm. The extrudate was granulated (pellet dimensions were about 4 mm) and dried to a moisture content of 9.3%-10.2%.

TABLE 1
Various starch based formulations used in Examples 2 to 6.

| | | | | | Palatibility | |
|---|---|---|---|---|---|---|
| Composition | Starch | Glycerol | Lecithin | Fibre | additive | Filler |
| A | 51.1% | 17.0% | 3.2% | 16.1% | 2.6% | 10% |
| B | 56.7% | 18.9% | 3.6% | 17.9% | 2.9% | — |
| C | 62.6% | 27.0% | 4.0% | 2.9% | 3.4% | — |

### Remarks:

All percentages mentioned are based on the dry solid weight of the total mixture;
Starch: Food grade native potato starch obtained from AVEBE, Veendam, The Netherlands;
Glycerol: type 1.26 glycerol vegetable obtained from Triconor, Soest, The Netherlands;
Lecithin: ADLEC DNGM obtained from Brenntag Nederland, The Netherlands;
Fibre: Arbocell BWW40 obtained from Rettenmaier Benelux, Zutphen, The Netherlands;
Filler: Omyacare S70-KP obtained from Omya SA/NV, Brussels, Belgium.
Palatibility additive: a mixture of potato starch, lupin flour and inactivated yeast.

### Description of Injection Moulding Machine

For injection moulding an Engel DUO 1100 (Schwertberg, Austria) was used with a clamping force of 1100 ton. This machine was equipped with 3 injection units:
Mucell unit.
For sandwich moulding two injection units with a screw diameter of 80 mm are available. Both units were equipped with general purpose plasticating screws. For sandwich moulding this machine was moreover equipped with an Engel sandwich hot-runner module.

### Mould

The mould, a 16-fold test chew mould (each product has a rectangular shape (cavity dimensions: length 230 mm, width 20 mm, thickness 5 mm) and should have a weight of 30 grams (final weight is dependent on exact material density) was provided by Verbi Gereedschappen B.V., Helmond, The Netherlands. This mould was equipped with a cold runner system. A maximum “Anti-Pragen” distance of 5 mm could be applied.

### Example 1. Foamed Skin-Core Product According to Invention Vs. Non-Stratified Foamed Product of Prior Art Microwave Method

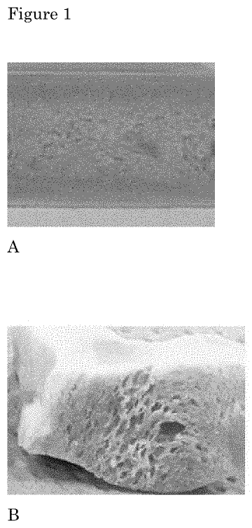

FIG. 1 (A) shows details of a section of a partly cellular injection moulding product produced in accordance with the invention as outlined in Example 2 (below), compared to a cellular product made by using the step of microwave heating of a starch composition prepared in accordance with methods as inter alia described in U.S. Pat. No. 6,180,161 in FIG. 1 (B).

### Example 2. Moulding of a Foamed Skin-Core Product Out of One Material

An injection moulding test was performed with the material composition A of Table 1. To this composition 1% of PlastronFoam F01-17 of Plastron SAS, France was added as a blowing agent by dry blending.

Injection moulding was performed with one of the injection units of the sandwich module. Temperature profile along the cylinder of the injection moulding machine was: feeding zone: 50° C.; zone 2: 50° C.; zone 3: 60° C.; zone 4: 80° C.; zone 5: 100° C.; zone 6: 120° C.; zone 7: 130° C.; zone 8: 130° C. The sandwich hot-runner module was tempered at 130° C. The fixed mould half (including cold runner) had a temperature of 35° C., the movable mould half was tempered at 25° C. Anti-präg distance (which was applied during the first part of the cooling phase) was maximized at 2 mm. Total cycle time was about 50 sec.

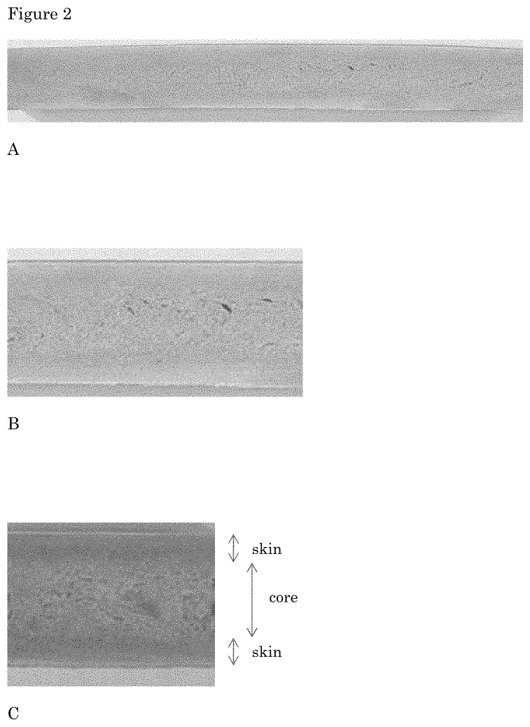

Obtained products can be characterized as a skin-core product, in which the skin (thickness 1.8 mm) consist of a non-cellular material (shore D value is 39.8) and the core consist of a homogeneous foamed material (shore D value is 33.0). (Outer) shape and dimensions are smooth and regular (no blisters) (see FIGS. 2 A and B) (length 220 mm, width 20 mm, thickness 7.3 mm). Products from different moulding cycles are identical to each other in terms of texture, shape, dimension and appearance.

Product characteristics are displayed in the table below.

TABLE 2
Product characteristics of skin-core product Example 2

| Composition | blowing | | | |
|---|---|---|---|---|
| product | agent | Anti-Prägen | Shore D skin | Shore D core |
| Composition | 1% | yes, max 2 | 39.8 [0.8] | 33 [0.9] |
| A | | mm | | |

### Example 3. Sandwich Moulding with 2 Different Materials Resulting in a Foamed Skin-Core Product

A sandwich injection moulding test was performed with material composition A (skin material) and material composition B (core material). To the core material 1% of PlastronFoam F01-17 of Plastron SAS, France was added by dry blending.

Injection moulding was performed with both injection units of the sandwich module. Temperature profile along both cylinders of the injection moulding machine were: feeding zone: 50° C.; zone 2: 50° C.; zone 3: 60° C.; zone 4: 80° C.; zone 5: 100° C.; zone 6: 120° C.; zone 7: 130° C.; zone 8: 130° C. The sandwich hot-runner module was tempered at 130° C. The fixed mould half (including cold runner) had a temperature of 35° C., the movable mould half was tempered at 25° C.

First material composition A was injected into the mould. After 40% of the total volume to be injected into the mould, the material supply switched over to material composition B (plus the Plastron additive). During the first part of the cooling phase “anti-prägen” was applied (mould opening distance was maximized at 2 mm). Total cycle time was about 50 sec.

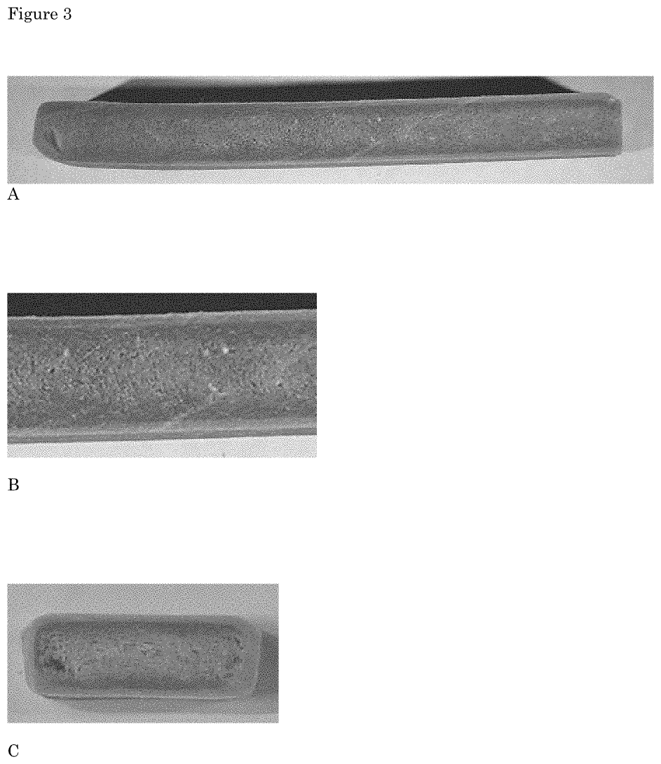

Obtained products can be characterized as a skin-core product, in which the skin consist of a non-cellular material (shore D value is 33.4) and the core consist of a homogeneous foamed material (shore D value is 23.6). (Outer) shape and dimensions are smooth and regular (no blisters) (see FIG. 3). Final thickness of the product is 7 mm. Products from different moulding cycles are identical to each other.

Product characteristics are displayed in the table below.

TABLE 3
Product characteristics of skin-core product Example 3

| Composition | Composition | blowing | Anti- | Shore | Shore D |
|---|---|---|---|---|---|
| skin | core | agent | Prägen | D skin | core |
| Composition | Composition | 1% | yes, 2 | 33.4 [1.3] | 23.6 [0.5] |
| A | B | | mm | | |

### Example 4. Sandwich Moulding with 2 Different Materials Resulting in a Non-Foamed Skin-Core Product

A sandwich injection moulding test was performed with material composition A (skin material) and material composition C (core material).

Injection moulding was performed with both injection units of the sandwich module. Temperature profile along both cylinders of the injection moulding machine were: feeding zone: 50° C.; zone 2: 50° C.; zone 3: 60° C.; zone 4: 80° C.; zone 5: 100° C.; zone 6: 120° C.; zone 7: 130° C.; zone 8: 130° C. The sandwich hot-runner module was tempered at 130° C. The fixed mould half (including cold runner) had a temperature of 35° C., the movable mould half was tempered at 25° C.

First composition A was injected into the mould. After 47% of the total volume to be injected into the mould, the material supply switched over to composition C. No “Anti-prägen” was applied. Total cycle time was about 50 sec.

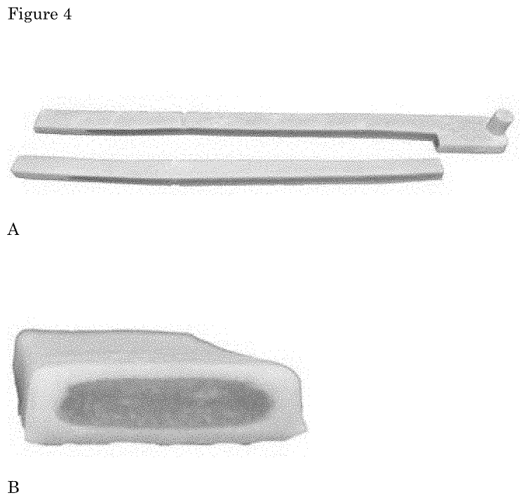

Obtained products can be characterized as a skin-core product, in which both skin and core consist of a non-cellular material (shore D value of the skin is 34.8 and shore D value of the core is 23.2). (Outer) shape and dimensions are smooth and regular (no blisters) (see FIG. 4). Products from different moulding cycles are identical to each other.

Product characteristics are displayed in the table below.

TABLE 4
Product characteristics of skin-core product Example 4,

| Composition | Composition | blowing | Anti- | Shore D | Shore D |
|---|---|---|---|---|---|
| skin | core | agent | Prägen | skin | core |
| Composition | Composition | 0% | no | 34.8 [0.8] | 23.2 [1.3] |
| A | C | | | | |

### Example 5. Effect of Anti-Präg Parameters on Product Properties

A series of sandwich injection moulding test were performed with material composition A (skin material) and material composition B (core material). To the core material 1% of PlastronFoam F01-17 of Plastron SAS, France was added by dry blending.

Injection moulding was performed with both injection units of the sandwich module. Temperature profile along both cylinders of the injection moulding machine were: feeding zone: 50° C.; zone 2: 50° C.; zone 3: 60° C.; zone 4: 80° C.; zone 5: 100° C.; zone 6: 120° C.; zone 7: 130° C.; zone 8: 130° C. The sandwich hot-runner module was tempered at 130° C. The fixed mould half (including cold runner) had a temperature of 35° C., the movable mould half was tempered at 25° C.

First material composition A was injected into the mould. After 40% of the total volume to be injected into the mould, the material supply switched over to material composition B (plus the Plastron additive). Total cycle time was about 50 sec.

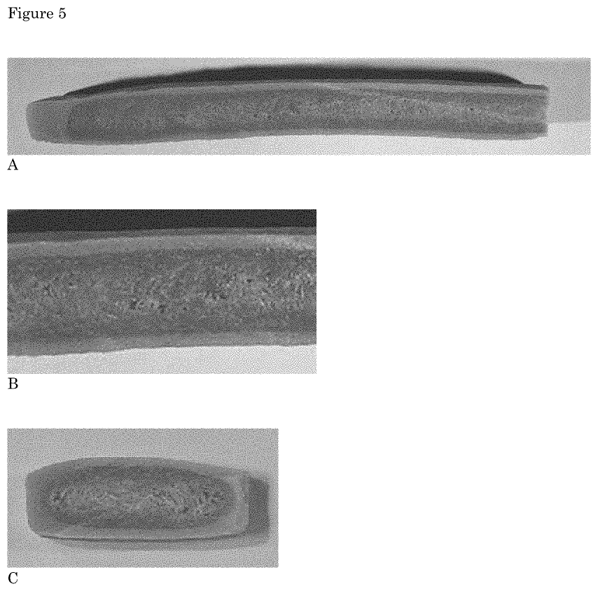

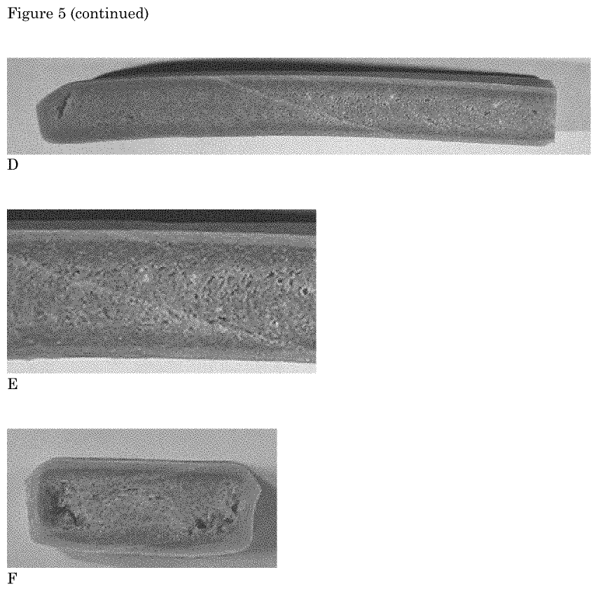

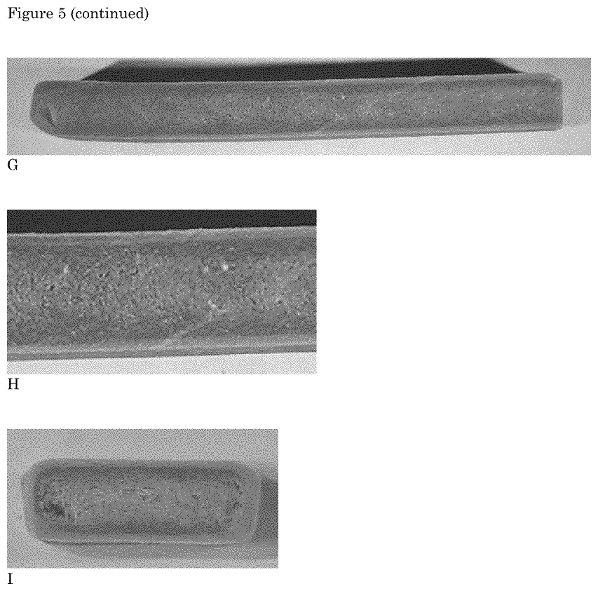

Three tests were performed:
Sample 5-1: During the first part of the cooling phase “anti-prägen” was applied (no maximum was applied; free distance (resulting in a distance of about 4 mm)). Obtained products can be characterized as a skin-core product, in which the skin consist of a non-cellular material (shore D value is 37) and the core consist of a irregular foamed material (shore D value is 23.6). The product is irregular in shape (not straight; cross section perpendicular to the flow direction has a more of less round shape instead of rectangular) and dimensions. Some blisters can be detected at the surface. Product is still rather hot when it is ejected out of the mould (see FIG. 5 A-C).
Sample 5-2: During the first part of the cooling phase “anti-prägen” was applied (mould opening distance was maximized at 3 mm). Obtained products can be characterized as a skin-core product, in which the skin consist of a non-cellular material (shore D value is 36.4) and the core consist of a rather homogeneous foamed material (shore D value is 21.6). The product is rather regular in shape and dimensions (see FIG. 5 D-F). Final thickness of the product is about 7.7 mm. When ejected the temperature of the product is significantly lower than sample 5-1.
Sample 5-3: During the first part of the cooling phase “anti-prägen” was applied (mould opening distance was maximized at 2 mm). Obtained products can be characterized as a skin-core product, in which the skin consist of a non-cellular material (shore D value is 33.4) and the core consist of a homogeneous foamed material (shore D value is 23.6). The product is more regular in shape and dimensions than sample 5-1 and 5-2. Mould dimensions are exactly copied to the product (see FIG. 5 G-I). Final thickness of the product is 7 mm. Due to the intense contact between mould and product cooling process is very efficient, resulting in lowest product temperatures when it is ejected.

Product characteristics are displayed in the table below.

TABLE 5
Product characteristics of skin-core product Example 5

| | | | | | Shore | Shore |
|---|---|---|---|---|---|---|
| | Composition | Composition | blowing | Anti- | D | D |
| Example | skin | core | agent | Prägen | skin | core |
| 5-1 | Composition | Composition | 1% | yes, no | 37 | 23.6 |
| | A | B | | limit | [1.9] | [0.5] |
| 5-2 | Composition | Composition | 1% | yes, | 36.4 | 21.6 |
| | A | B | | max 3 | [0.5] | [0.9] |
| | | | | mm | | |
| 5-3 | Composition | Composition | 1% | yes, | 33.4 | 23.6 |
| | A | B | | max 2 | [1.3] | [0.5] |
| | | | | mm | | |

### Example 6. Combined Effects of Anti-Präg Parameters and Addition of Blowing Agents on Product Properties

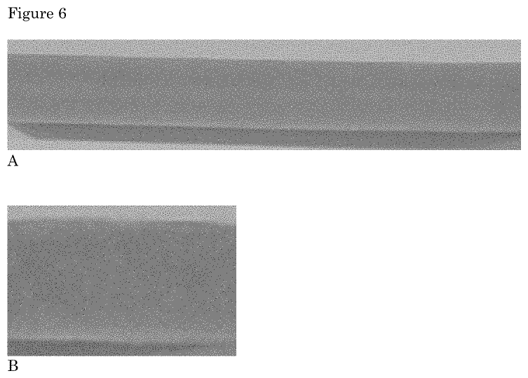

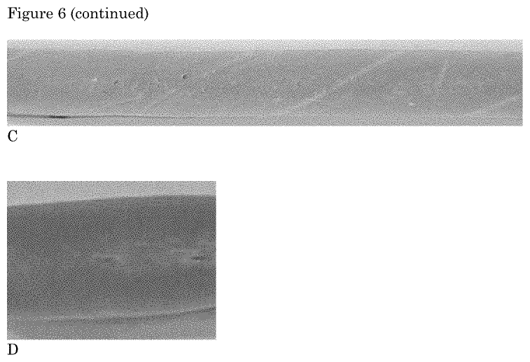

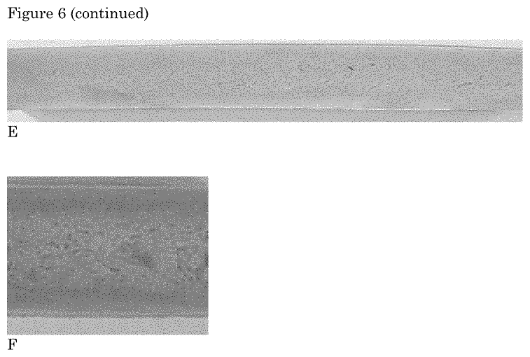

Injection moulding was performed with one of the injection units of the sandwich module. Temperature profile along the cylinder of the injection moulding machine was: feeding zone: 50° C.; zone 2: 50° C.; zone 3: 60° C.; zone 4: 80° C.; zone 5: 100° C.; zone 6: 120° C.; zone 7: 130° C.; zone 8: 130° C. The sandwich hot-runner module was tempered at 130° C. The fixed mould half (including cold runner) had a temperature of 35° C., the movable mould half was tempered at 25° C. Total cycle time was about 50 sec.
Sample 6-1: samples have been injection moulded from material composition A. No “Anti-prägen” was applied. Obtained products can be characterized as an almost homogeneous, non-cellular product (shore D value of the skin is 47.2 and shore D value of the core is 46.2). The product is regular in shape and dimensions (see FIG. 6, A-B).
Sample 6-2: samples have been injection moulded from material composition A. During the first part of the cooling phase “anti-prägen” was applied (no maximum was applied; free distance (resulting in about 4 mm)). Obtained products can be characterized as an irregular, skin-core product (shore D value of the skin is 40.2 and shore D value of the core is 35.4). Due to the effect that there is no additional blowing agent except from water, the foamed core is rather small, foam structure is coarse. The product is irregular in shape and dimensions (see FIG. 6, C-D).
Sample 6-3: samples have been injection moulded from material composition A. To this composition 1% of PlastronFoam F01-17 of Plastron SAS, France was added by dry blending. Anti-präg distance (which was applied during the first part of the cooling phase) was maximized at 2 mm. Obtained products can be characterized as a skin-core product, in which the skin consist of a non-cellular material (shore D value is 39.8) and the core consist of a homogeneous foamed material (shore D value is 33.0). (Outer) shape and dimensions are smooth and regular (no blisters) (see FIG. 6, E-F). Products from different moulding cycles are identical to each other.

Product characteristics are displayed in the table below.

TABLE 6
Product characteristics of skin-core product Example 6.

| | Composition | blowing | Anti- | Shore D | Shore |
|---|---|---|---|---|---|
| Example | Product | agent | Prägen | skin | D core |
| 6-1 | Composition | 0% | no | 47.2 [0.8] | 46.2 [0.8] |
| | A | | | | |
| 6-2 | Composition | 0% | yes, | 40.2 [1.8] | 35.4 [1.1] |
| | A | | free | | |
| | | | way | | |
| 6-3 | Composition | 1% | yes, | 39.8 [0.8] | 33 [0.9] |
| | A | | max 2 | | |
| | | | mm | | |

TABLE 7
Overview Shore tests in the examples 2-6
Shore D was tested according to ISO 868

| | Composition | | Plastron | | Shore D | |
|---|---|---|---|---|---|---|
| Sample | Material 1 | Material 2 | F01-17 | Anti-Prägen | Skin | Core |
| Example 2 | Composition | — | 1% | yes, max 2 mm | 39.8 [0.8] | 33 [0.9] |
| | A | | | | | |
| Example 3 | Composition | Composition | 1% | yes, max 2 mm | 33.4 [1.3] | 23.6 [0.5] |
| | A | B | | | | |
| Example 4 | Composition | Composition | 0% | no | 34.8 [0.8] | 23.2 [1.3] |
| | A | C | | | | |
| Example 5-1 | Composition | Composition | 1% | yes, no limits | 37 [1.9] | 23.6 [0.5] |
| | A | B | | | | |
| Example 5-2 | Composition | Composition | 1% | yes, max 3 mm | 36.4 [0.5] | 21.6 [0.9] |
| | A | B | | | | |
| Example 5-3 | Composition | Composition | 1% | yes, max 2 mm | 33.4 [1.3] | 23.6 [0.5] |
| | A | B | | | | |
| Example 6-1 | Composition | — | 0% | no | 47.2 [0.8] | 46.2 [0.8] |
| | A | | | | | |
| Example 6-2 | Composition | — | 0% | yes | 40.2 [1.8] | 35.4 [1.1] |
| | A | | | | | |
| Example 6-3 | Composition | — | 1% | yes, max 2 mm | 39.8 [0.8] | 33 [0.9] |
| | A | | | | | |

### Example 7. Production of a Further Thermoplastic Starch Granulate

A powder/fluid mixture according to various specified formulations (see table below) were extruded on a Buhler Twin Screw extruder DNDF-93 (L/D=48) extruder (12 barrel elements). The temperature profile along the barrel was: zone 1: 15-25° C.; zone 2: 15-25° C.; zone 3: 115-120° C.; zone 4: 135-145° C.; zone 5: 135-145° C.; zone 6: 100-105° C.; zone 7: 95-105° C.; zone 8: 70-90° C.; zone 9: 60-90° C. (incl. vacuum); zone 10: 60-90° C.; zone 11: 60-90° C. (incl. vacuum); zone 12: 50-60° C. Set point of the die temperature was 85-95° C. Screw speed was 125 rpm. The extrudate was granulated (pellet dimensions were about 4 mm) and dried to a moisture content of 9.3%-10.2%.

TABLE 8
Various starch based formulations used in Examples 7 to 11.

| | | | | | Palatibility | |
|---|---|---|---|---|---|---|
| Composition | Starch | Glycerol | Lecithin | Fibre | additive | Filler |
| D | 51.1% | 17.0% | 3.2% | 16.1% | 2.6% | 10% |
| B | 56.7% | 18.9% | 3.6% | 17.9% | 2.9% | — |
| C | 62.6% | 27.0% | 4.0% | 2.9% | 3.4% | — |

Compared to Table 1, composition D replaces composition A and differs in the type of Filler used.

### Remarks:

All percentages mentioned are based on the dry solid weight of the total mixture
Starch: Food grade native potato starch obtained from AVEBE, Veendam, The Netherlands
Glycerol: type 1.26 glycerol vegetable obtained from Triconor, Soest,

The Netherlands
Lecithin: ADLEC DNGM obtained from Brenntag Nederland, The Netherlands
Fibre: Arbocell BWW40 obtained from Rettenmaier Benelux, Zutphen, The Netherlands
Filler: Sibelite M72 obtained from SCR Sibelco NV, Dessel, Belgium.
Palatibility additive: as for Table 1.

The injection moulding machine as described above in the general Material and Methods section.

### Moulds:

The mould, a 16-fold test chew mould (each product has a rectangular shape (cavity dimensions: length 220 mm, width 20 mm, thickness 5 mm) was provided by Verbi Gereedschappen B.V., Helmond, The Netherlands. This mould was equipped with a cold runner system. Maximum “Anti-Pragen” distance of 6 mm is possible.

### Example 8. Effect of Anti-Prägen During Injection Phase

### Description Injection Moulding Process

A sandwich injection moulding test was performed with material composition D (skin material) and material composition C (core material) as indicated in Example 7.

Injection moulding was performed with both injection units of the sandwich module. Temperature profile along both cylinders of the injection moulding machine were: feeding zone: 50° C.; zone 2: 50° C.; zone 3: 60° C.; zone 4: 80° C.; zone 5: 100° C.; zone 6: 120° C.; zone 7: 130° C.; zone 8: 130° C. The sandwich hot-runner module was tempered at 130° C. The fixed mould half (including cold runner) had a temperature of 35° C., the movable mould half was tempered at 25° C.

First, composition D was injected into the mould. After 49.4% of the total volume to be injected into the mould, the material supply switched over to composition C. Anti-präg distance (which was applied during the injection phase) was maximized at 3 mm.

Test 8-1: The mould was closed and subsequently opened for 3 mm (before injection; so total cavity height is 8 mm). A total amount of 750 cm³ material (no gas was dosed into the melt) was injected into the mould with an injection speed of 200 cm³/s; after injection of the material, no holding phase was applied. After the holding phase, a cooling time of 30 sec was applied (the anti-prägen function during injection and/or cooling was not active during this cycle). Finally, the mould was opened and the products were ejected from the mould.
Test 8-2: The mould was closed and locked with a clamping force of 2500 kN. An amount of 750 cm³ material (no gas was dosed into the melt) was injected into the mould with an injection speed of 200 cm³/s; during injection the mould was opened for 3 mm. After injection of the material, no holding phase was applied. After the holding phase, a cooling time of 30 sec was applied. Finally the mould was fully opened and the products were ejected from the mould.

### Description of Produced Products

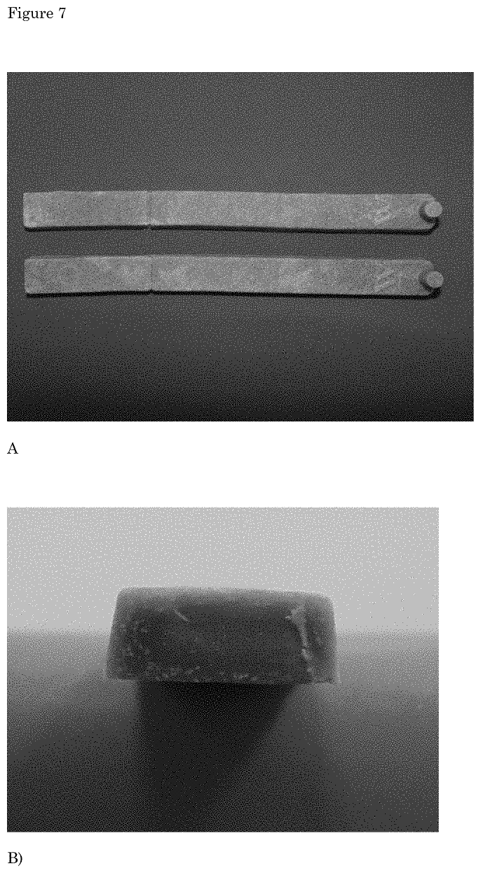

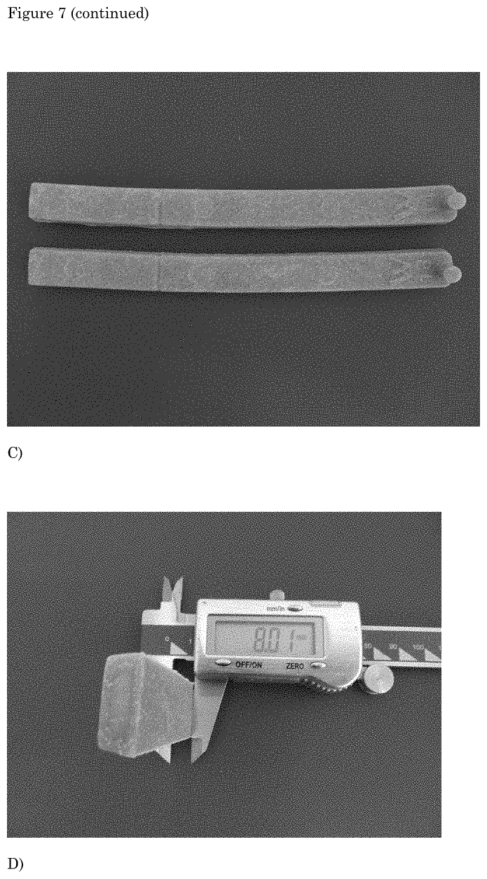

Products are displayed in FIG. 7. Weight of the products produced in test 8-1 (FIGS. 7A and 7B; no anti-prägen function) and test 8-2 (FIGS. 7C and 7D; anti-prägen function active during the injection phase) is comparable and between 50 and 51 gram/product. Both products series consist of solid, non cellular products. The essential difference between both products can be seen when viewing product surface details (see FIG. 7A vs. FIG. 7C): e.g. when the letter “W” on the right-hand side of the product and product number on products of test 8-1 have a somewhat foamy appearance (white spots on the surface) and product details are somewhat vague. On the other hand, products of test 8-2 have a more homogeneous appearance (without white spots). Mould details are accurately copied into the moulded product. Shore D hardness of product from test 8-1: between 44 and 46 for skin and between 36 and 38 for core. Shore D hardness of product from test 8-2: between 44 and 46 for skin, and between 37 and 40 for core. The average density of both products is between 1.44 and 1.50 gram/cm³. The thickness of product 8-2 is 8.0 mm.

### Example 9. Effect of Anti-Prägen During Injection Phase and Cooling Phase

### Description Injection Moulding Process

Two injection moulding tests were performed with material composition C as described in Example 7. To this material 1% of PlastronFoam F01-17 of Plastron SAS, France was added by dry blending.

Injection moulding was performed with one of the injection units of the sandwich module. Temperature profile along the cylinder of the injection moulding machine was: feeding zone: 50° C.; zone 2: 50° C.; zone 3: 60° C.; zone 4: 80° C.; zone 5: 100° C.; zone 6: 120° C.; zone 7: 130° C.; zone 8: 130° C. The sandwich hot-runner module was tempered at 130° C. The fixed mould half (including cold runner) had a temperature of 35° C., the movable mould half was tempered at 25° C. Total anti-präg distance (which could be applied during both the injection phase and the cooling phase) was maximized at 5 mm (3+2 mm, for “during injection” and “during cooling” “anti-prägen, respectively).

Test 9-1: The mould was closed and locked with a clamping force of 2500 kN. An amount of 750 cm³ material was injected into the mould with an injection speed of 200 cm³/s; during injection the mould was opened for 3 mm. After injection of the material, a holding pressure of 750 bar was applied for 1 sec. After the holding phase, a cooling time of 30 sec was applied. Finally the mould was fully opened and the products were ejected from the mould.
Test 9-2: The mould was closed and locked with a clamping force of 2500 kN. An amount of 750 cm³ material was injected into the mould with an injection speed of 200 cm³/s; during injection the mould was opened for 3 mm. after injection of the material, a holding pressure of 750 bar was applied for 1 sec. Moreover after the holding phase and during the cooling phase (of 30 sec) the mould was further opened for 2 mm. Finally the mould was fully opened and the products were ejected from the mould.

### Description of Produced Products

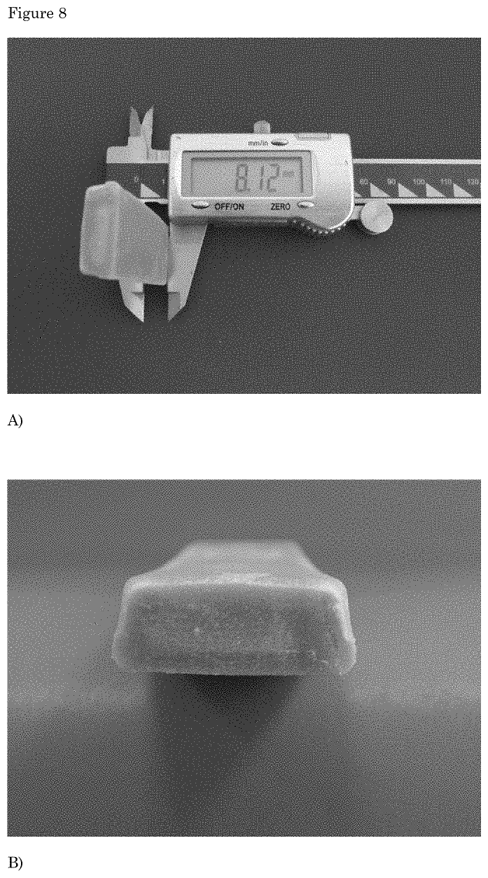

Products are displayed in FIG. 8. Weight of the products produced in test 9-1 and test 9-2 is slightly different 50-51 gram/product (test 9-1) resp. 54-55.5 gram/product (test 9-2). Products of products series 9-1 (FIGS. 8A and 8B; anti-prägen function during injection phase) consist of solid, non cellular products having no hardness stratification between skin and core and a thickness of 8.1 mm. Products of product series 9-2 (FIGS. 8C and 8D; anti-prägen function during injection phase and cooling phase) consist of a cellular core consisting of a homogeneous foamed material (shore D value 28-30) with a non-cellular skin material (shore D value 40-41) and a thickness of 10.0 mm. (Outer) shape and dimensions are smooth and regular (no blisters) (see FIGS. 8C and 8D). The average density of products from test 9-1 is between 1.44 and 1.48 grams/cm³; the average density of products from test 9-2 is between 1.18-1.21 grams/cm³.

A product thickness of at least 10 mm for an injection moulded pet chew product can be obtained in this process wherein a single plasticized starch matrix is injected into the injection mould using anti-prägen function during both injection and cooling phases in a single melt and cooling cycle.

### Example 10. Sandwich Moulding with 2 Different Materials Resulting in a Foamed Skin-Core Product

### Description Injection Moulding Process

A sandwich injection moulding test was performed with material composition D (skin material) and material composition C (core material). To material composition C, 1% of PlastronFoam F01-17 of Plastron SAS, France was added by dry blending.

Injection moulding was performed with both injection units of the sandwich module. Temperature profile along both cylinders of the injection moulding machine were: feeding zone: 50° C.; zone 2: 50° C.; zone 3: 60° C.; zone 4: 80° C.; zone 5: 100° C.; zone 6: 120° C.; zone 7: 130° C.; zone 8: 130° C. The sandwich hot-runner module was tempered at 130° C. The fixed mould half (including cold-runner) had a temperature of 35° C., the movable mould half was tempered at 25° C.

First, composition D was injected into the mould. After 49.9% of the total volume to be injected into the mould, the material supply switched over to composition C (+1% of PlastronFoam). Total anti-präg distance (which could be applied during both the injection phase and the cooling phase) was maximized at 5 (3+2 mm) mm.

Test 10-1: The mould was closed and locked with a clamping force of 2500 kN. An amount of 750 cm³ material was injected into the mould with an injection speed of 200 cm³/s; during injection the mould was opened for 3 mm. After injection of the material, no holding phase was applied. After the holding phase, a cooling time of 30 sec was applied. Finally the mould was fully opened and the products were ejected from the mould.
Test 10-2: The mould was closed and locked with a clamping force of 2500 kN. An amount of 750 cm³ material was injected into the mould with an injection speed of 200 cm³/s; during injection the mould was opened for 3 mm. After injection of the material, no holding phase was applied. Moreover, during the cooling phase (of 30 sec) the mould was further opened for 2 mm. Finally, the mould was fully opened and the products were ejected from the mould.

### Description of Produced Products

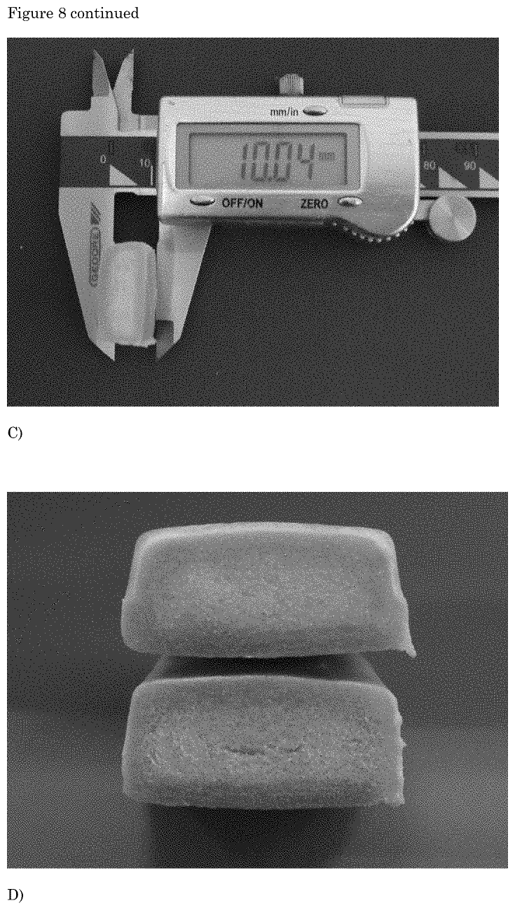

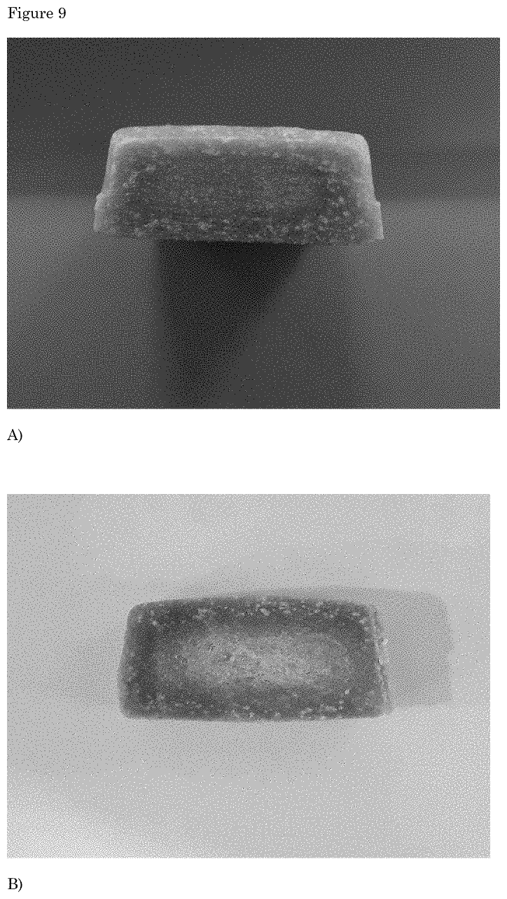

Products are displayed in FIG. 9. Weight of the products produced in test 10-1 and test 10-2 is slightly different 50-51 gram/product (test 10-1) resp. 54-55.5 gram/product (test 10-2). Products of products series 10-1 (FIG. 9A; anti-prägen function during the injection phase) consist of skin-core and non cellular structure. Products of product series 10-2 (FIG. 9B; anti-prägen function during both the injection and cooling phase) consist of a skin-core product, in which the skin consist of a non-cellular material (shore D value is 44-46) and the core consist of a homogeneous foamed material (shore D value is 35-38) (FIG. 9B). (Outer) shape and dimensions are smooth and regular (no blisters). Mould details are accurately copied into the moulded product. The average density of products from test 10-1 is between 1.41 and 1.44 gram/cm³; the average density of products from test 10-2 is between 1.36-1.38 gram/cm³.

### Example 11. Sandwich Moulding with 2 Different Materials Resulting in a Foamed Skin-Core Product for Use in Kennel Tests

### Description Production Procedure of the Test and Reference Products

The mould as described in example 7 was modified to a allow a maximum “anti-prägen” distance of 10 mm (7+3 mm).

### Sample B1 (Skin-Core Test Product)

A sandwich injection moulding procedure was performed with material composition D (skin material) and material composition B (core material). To material composition B, 1% of PlastronFoam F01-17 of Plastron SAS, France was added by dry blending.

Injection moulding was performed with both injection units of the sandwich module. Temperature profile along both cylinders of the injection moulding machine were: feeding zone: 50° C.; zone 2: 50° C.; zone 3: 60° C.; zone 4: 80° C.; zone 5: 100° C.; zone 6: 120° C.; zone 7: 130° C.; zone 8: 130° C. The sandwich hot-runner module was tempered at 130° C. The fixed mould half (including cold runner) had a temperature of 35° C., the movable mould half was tempered at 25° C.

First, composition D was injected into the mould. After 27.4% of the total volume of 935 cm³ to be injected (at 200 cm³/s) was injected into the mould, the material supply switched over to composition B (+1% of PlastronFoam F01-17). Total anti-präg distance (which could be applied during both the injection phase and the cooling phase) was maximized at 10 mm: during injection the mould was opened under “anti-prägen” for 6 mm. After injection of the material, no holding phase was applied. Moreover, during the cooling phase (of 40 sec) the mould was further opened under “anti-prägen” for 3 mm. Finally, the mould was fully opened and the products were ejected from the mould. A total of 200 products was produced.

### Sample B2

Injection moulding was performed with one of the injection units of the sandwich module. Temperature profile along the cylinder of the injection moulding machine was: feeding zone: 50° C.; zone 2: 50° C.; zone 3: 60° C.; zone 4: 80° C.; zone 5: 100° C.; zone 6: 120° C.; zone 7: 130° C.; zone 8: 130° C. The sandwich hot-runner module was tempered at 130° C. The fixed mould half (including cold runner) had a temperature of 35° C., the movable mould half was tempered at 25° C.

After closing the mould, Composition B was injected into the mould (in total 465 cm³) at 200 cm³/s. No “anti-prägen” was used. After a cooling phase of 30 sec the mould was opened and the products were ejected from the mould. A total of 200 products was produced.

### Description of Produced Products

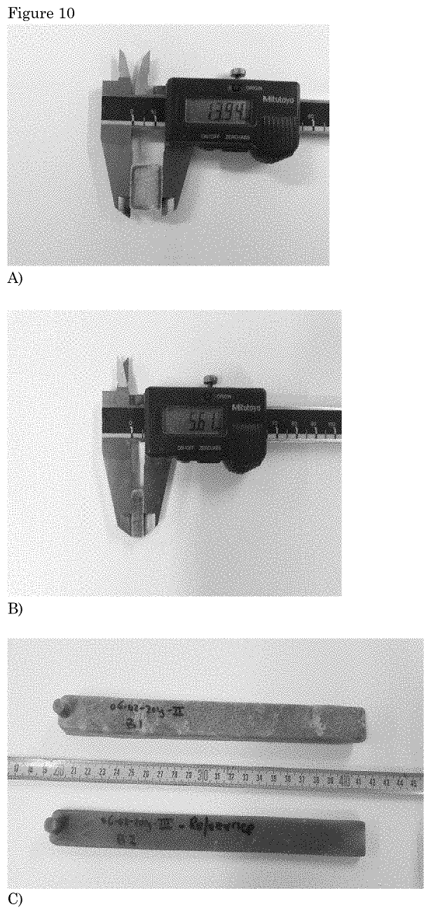

Products are displayed in FIG. 10. Weight of the products produced was 23-24 gram/product for sample series B1, and 12-13 gram/product for sample series B2. Products from sample series B1 (FIGS. 10A and 10Ctop; anti-prägen function during both the injection and cooling phase) consist of a skin-core product, in which the skin consist of a non-cellular material (shore D value is 31-32) and the core consist of a homogeneous foamed material (shore D value is 21-22). (Outer) shape and dimensions are smooth and regular (no blisters). Mould details are accurately copied into the moulded product. The average density of sample series B1 is between 0.90 and 0.95 gram/cm³. A product thickness of at least 13 mm for an injection moulded pet chew product can be obtained in this process wherein two different plasticized starch matrices are injected in sandwich-mode into the injection mould and wherein an anti-prägen function during both injection and cooling phases in a single melt and cooling cycle is used.

Products from sample series B2 (FIGS. 10B and 10Cbottom; no anti-prägen function) consist of solid, non-cellular products having almost no hardness difference between skin and core (shore D value is 34-36). The average density of products is between 1.1-1.3 gram/cm³.

### Example 12. Kennel Tests

### Methodology

In order to determine the cleansing effect of a large dimension skin-core product according to the present invention on teeth of dogs, a product of sample series B1 was compared to a product of sample series B2, produced as described in Example 11, in a kennel test using a total of 30 dogs. Tests were carried out at an independent expert kennel specialized in palatability tests and studies on cats and dogs feeding behavior.

A palatability test was carried out for 28 days using 15 dogs for the B1 test product and 15 dogs for the B2 reference product. Dogs in the test group received 1 specimen of B1 test product per day. Dogs in the reference group received 1 specimen of B2 reference product per day. Dogs were individual housed at feeding time, and spend the remainder of the day in groups at a dog playground. Each dog was presented with 1 specimen of the test or reference product and rate of consumption was visually determined at three time points daily over a period of 18 hrs (0.5, 3 and 18 hrs) during the 28 days study. Observations were made by a single investigator. Scoring was 0 (not touched), 0.1 (10% consumed), 0.5 (50% consumed), 1.0 (100% consumed). The daily scores for individual time points in each group were combined to give the amount of product consumed at that time point as a percentage over the test or reference group. The combined daily scores over the 28 day period provided an objective indication of the rate of consumption and hence the preference of the product.

Further, in the same dogs, the amount of plaque and tartar was visually scored on a scale of 0-4 (low-high plaque/tartar) at days 0, 14 and 28 by a single investigator using a dental-plaque-disclosing agent. The presence of gum disease (inflammation) was also visually scored on a scale of 0-4 (low-high disease) at days 0, 14 and 28 by a single investigator.

### Results

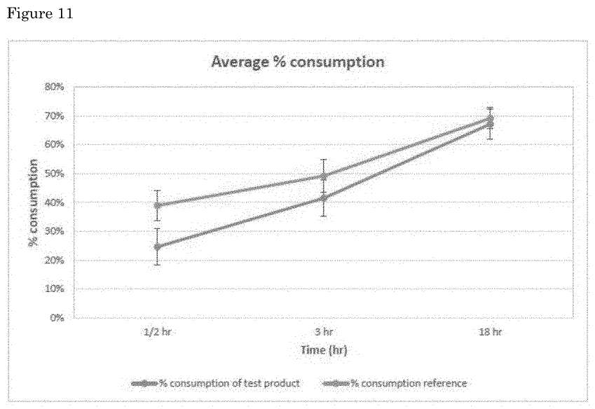

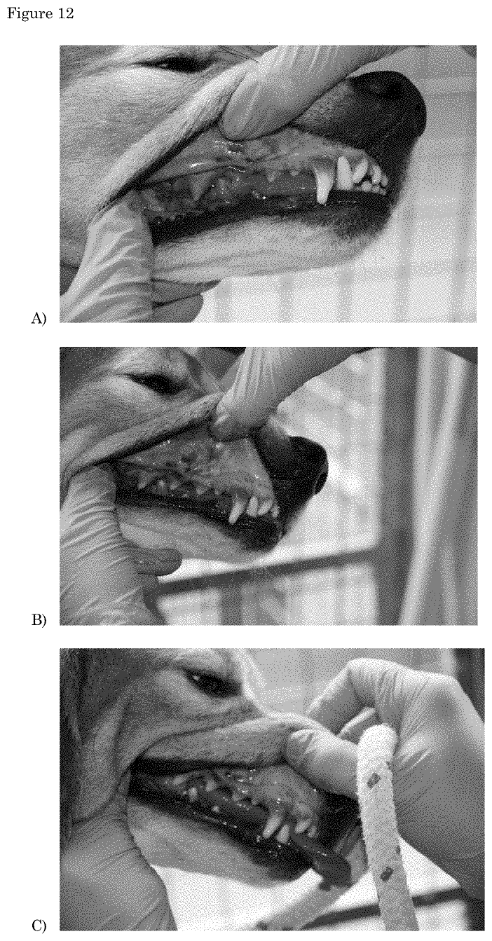

The average consumption of B1 test product and B2 reference product is provided in FIG. 11. At 0.5 hrs., less of the test product had been consumed compared to the reference product. At 18 hrs., both the reference and test products B2 were completely consumed in about 70% of the cases. Based on this, there was no important difference in preference of the dogs for either of the products.

Average plaque/tartar scores were 2.50 on both days 0 and 14 for the B1 test group, and 2.53 on both days 0 and 14 for the B2 reference group. Average gum disease scores were 1.53 and 1.73 on day 0 and 14, respectively, for the B1 test group, and 1.57 and 1.71 on day 0 and 14, respectively, for the B2 reference group.

In the table below, the results are presented for the plaque/tartar and gum disease tests at day 28. Numbers are average values for 15 dogs per group and based on the 0-4 score levels described above.

TABLE 9
Results of Example 12
Day 28 plaque reduction comparison

| | Plaque and | gum |
|---|---|---|
| | tartar | disease |
| B2 Reference | 2.60 | 1.87 |
| B1 Test | 2.21 | 1.64 |
| % reduction | 15%* | 12% |

*Significant reduction of tartar with one-tail t-test

A statistically significant reduction in plaque and tartar was observed at day 28 when comparing the B1 test group receiving the product according to the present invention, with the B2 reference group receiving the reference product. Gum disease was also reduced in the B1 test group compared to the reference group.

The above results obtained with kennel tests indicate that the product of the present invention is able to control dental health problems in domesticated pets by reducing dental plaque.

1. A method for producing a pet chew product by a single injection molding cycle, comprising the steps of:
a) providing a thermoplastic starch mixture comprising 95-30 wt. % based on dry solid weight of the mixture of a starch or a starch derivative, 5-40 wt. % based on dry solid weight of the mixture of a plasticizer, and 0-30 wt. % based on dry solid weight of the mixture of a fibrous material;
b) converting said mixture into a thermoplastic starch-based melt by subjecting the mixture to a step wherein the starch is destructurized;
c) optionally mixing a blowing agent into the thermoplastic starch-based melt;
d) injecting the resulting thermoplastic melt comprising said optional blowing agent in a mould cavity while partially opening the mould during melt injection;
e) allowing the thermoplastic melt in contact with the mould cavity wall to at least partially cool and set thereby forming the outer skin of a first density or hardness;
f) partially opening the mould during melt cooling to allow gas expansion in the non-cooled core of the injected thermoplastic melt and formation of a foamed core of a second density or hardness;
g) allowing the melt to cool and set, and
h) ejecting the pet chew product from the mould cavity.

2. A method for producing a pet chew product by a single injection molding cycle, comprising the steps of:
a) providing a first thermoplastic starch mixture having a first density or hardness comprising 95-30 wt. % based on dry solid weight of the mixture of a starch or a starch derivative, 5-40 wt. % based on dry solid weight of the mixture, of a plasticizer, and 0-30 wt. % based on dry solid weight of the mixture of a fibrous material;
b) converting said first mixture into a first thermoplastic starch-based melt by subjecting the mixture to step wherein the starch is destructurized;
c) providing a second thermoplastic starch mixture having a second density or hardness, lower than the first mixture, said second mixture comprising 95-30 wt. % based on dry solid weight of the mixture of a starch or a starch derivative, 5-40 wt. % based on dry solid weight of the mixture of a plasticizer, and 0-30 wt. % based on dry solid weight of the mixture of a fibrous material;
d) converting said second mixture into a second thermoplastic starch-based melt by subjecting the mixture to step wherein the starch is destructurized, and optionally adding a blowing agent to the mixture;
e) injecting the first and second melt in a mould cavity using a two shot or sandwich moulding process for combining the first and second thermoplastic starch melts in the mould cavity while partially opening the mould during melt injection, wherein the first thermoplastic melt is injected to be in contact with the mould cavity wall and wherein the second thermoplastic melt is injected with respect to the first thermoplastic melt so as to be enveloped by it, whereby the partial opening the mould during melt injection may be during the first and/or second melt injection, preferably during the second melt injection;
f) allowing the first and second melt to cool and set, optionally while partially opening the mould during the cooling step, and
g) ejecting the pet chew product from the mould cavity.

3. Method according to claim 1 or 2, wherein the thermoplastic starch-based melt comprises a blowing agent selected from super critical fluids, nitrogen gas, carbonates, bicarbonates, nitrites, hydrides, peroxides, and oxygen-containing acid derivatives, preferably bicarbonates.

4. Method according to any one of the preceding claims, wherein the step of partially opening the mould during the injection step comprises opening the mould for between 1-15 mm.

5. Method according to any one of the preceding claims, wherein the step of partially opening the mould during the cooling step comprises opening the mould for between 1-15 mm.

6. Method according to any one of the preceding claims, wherein the moisture content of the thermoplastic starch mixture or the first and second thermoplastic starch mixtures is conditioned to 5 to 20 wt. %, preferably from 6 to 15 wt. %, more preferably from 7 to 10 wt. %, based on the total weight of the thermoplastic starch.

7. Injection moulded pet chew product produced by the method according to any one of claims 1-6.

8. Injection moulded pet chew product according to claim 7, whereby the pet chew is expanded as compared to a product produced with thermoplastic starch-based materials of the same composition in the same mould using the same method from which the step of partially opening the mould during melt injection has been omitted.

9. Injection moulded pet chew product according to claim 8, whereby the pet chew is additionally expanded as compared to a product produced with thermoplastic starch-based materials of the same composition in the same mould using the same method, wherein the method of the product for comparison comprises step f) of claim 1, and wherein the method of the product for comparison does not comprise the step of partially opening the mould during melt injection.

10. Injection moulded pet chew product according to any one of claims 7-9, wherein the thickness of the product is at least 8 mm, or wherein the thickness of the skin is between 0.3-8 mm, preferably 2-8 mm.

11. Injection moulded pet chew product according to any one of claims 7-10, wherein the thermoplastic starch-based material(s) have a protein content of less than 4 wt. % based on dry solid weight of the mixture.

12. Injection moulded pet chew product according to any one of claims 7-11, wherein the difference in hardness between the skin and the core is between 1-50 Shore D hardness units, and preferably wherein the Shore D hardness of the skin is >22 and wherein the Shore D hardness of the core is <40.

13. Injection moulded pet chew product according to any one of claims 7-12, wherein the thermoplastic starch-based material(s) comprise an abrasive agent, preferably in particle form, preferably having a Mohs hardness of between 0.5 and 8, preferably between 1 and 7, preferably selected from the group consisting of carbonates, hydrated magnesium silicates, phyllosillicates, apatite-like materials, silica's, and combinations thereof, preferably wherein the abrasive agent is present in an amount of between 0 and 20 wt. %, based on the dry weight of the mixture.

14. Injection moulded pet chew product according to any one of claims 7-13, wherein the at least partial opening of the mould plates during the injection phase is the result of a partial separation of the mould plates for between 1-10 mm, and wherein the at least partial opening of the mould during the cooling phase is the result of a partial separation of the mould plates for between 1-10 mm.

15. Injection moulded pet chew product comprising a skin of a first thermoplastic starch-based material enveloping a core of a second thermoplastic starch-based material, wherein the first and second thermoplastic starch-based materials may be the same or different, the core having a density or hardness lower than the skin, wherein the pet chew product is produced in a single injection moulding cycle using a first mould decompression step during the injection phase and a second mould decompression step during the cooling.

16. Injection moulded pet chew according to claim 15, wherein the skin comprises a non-cellular thermoplastic starch-based material, and wherein the core comprises a foamed or cellular thermoplastic starch-based material.

17. Injection moulded pet chew according to claim 15 or 16, wherein the first, second or both thermoplastic starch-based materials have a protein content of less than 4 wt. % based on the total weight of the starch.

18. Injection moulded pet chew according to any one of claims 15-17, wherein the pet chew has a thickness of at least 10 mm.

19. Injection moulded pet chew according to any one of claims 15-18, wherein the difference in hardness between the skin and the core is between 1-50 Shore D hardness units, and preferably wherein the Shore D hardness of the skin is >22 and wherein the Shore D hardness of the core is <40.

20. Injection moulded pet chew according to any one of claims 15-19, wherein the composition of the first and/or second thermoplastic starch materials comprise 95-30 wt. %, preferably 89-40 wt. %, based on dry solid weight of the composition, of a starch or a starch derivative, 5-40 wt. %, preferably 10-35 wt. %, based on dry solid weight of the composition, of a plasticizer, and 0-30 wt. %, preferably 1-25 wt. %, based on dry solid weight of the composition, of a fibrous material, preferably consisting of fibers having a length of between 23 and 2000 μm.
